(19) United States
(12) Patent Application Publication
(10) Pub. No.: US 2025/0260984 A1
(43) Pub. Date: Aug. 14, 2025

(54) FIRST NODE, SECOND NODE, THIRD NODE AND METHODS PERFORMED THEREBY FOR HANDLING INFORMATION

(71) Applicant: Telefonaktiebolaget LM Ericsson (publ), Stockholm (SE)

(72) Inventors: Emiliano MERINO VAZQUEZ, Leganés, Madrid (ES); Jose Miguel DOPICO SANJUAN, Torrelodones, Madrid (ES); Juan Manuel FERNANDEZ GALMES, Getafe (ES)

(73) Assignee: Telefonaktiebolaget LM Ericsson (publ), Stockholm (SE)

(21) Appl. No.: 18/844,048

(22) PCT Filed: Sep. 21, 2022
(86) PCT No.: PCT/EP2022/076235

§ 371 Date: Sep. 4, 2024

(30) Foreign Application Priority Data
Mar. 14, 2022 (EP) 22382242.0

(51) Int. Cl. H04W 12/10; H04W 8/00; H04W 8/22; H04W 60/04

(52) U.S. Cl. CPC H04W 12/10; H04W 8/005; H04W 8/22; H04W 60/04

(57) ABSTRACT

A computer-implemented method, performed by a first node (111). The method is for handling information. The first node (111) operates in a communications system (100). The first node (111) sends (701) a first indication to a second node (112) operating in the communications system (100). The first indication indicates a capability of the first node (111) to receive a notification. The notification indicates a change to information pertaining to an integrity of a group of devices (130) operating in the communications system (100). The first node (111) receives (702), based on the sent first indication, a first notification from a third node (113) operating in the communications system (100). The first notification indicates a first change to the information pertaining to the group of devices (130). The first change affects two or more of the devices in the group of devices (130).

### TECHNICAL FIELD

The present disclosure relates generally to a first node and methods performed thereby for handling information. The present disclosure also relates generally to a second node, and methods performed thereby for handling the information. The present disclosure further relates generally to a third node, and methods performed thereby for handling the information.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. In case the AF may be trusted, e.g., internal to the network operator, the AF may interact with the 3GPP Core Network directly, with no NEF involved. The NEF 2 may support different functionality, e.g., different Exposure Application Program Interfaces (APIs), e.g., sponsored Data, Quality of Service (QoS), etc. . . . , which may allow a content provider to request policies from the Mobile Network Operator (MNO). A Unified Data Repository (UDR), which is not depicted, may store data grouped into distinct collections of subscription-related information: subscription data, policy data, structured data for exposure, and application data. A Unified Data Manager Function (UDM) 3 may generate 3GPP 5G AKA Authentication Vectors, handle user identification handling, support a UE's Serving NF Registration Management, e.g., storing the serving Access and Mobility Function (AMF) for a UE, storing the serving Session Management Function (SMF) for a UE's Packet Data Unit (PDU) Session, etc., support retrieval of the UE's individual subscription data for slice selection, and handle subscription data for network exposure capabilities applicable to an individual UE or a group of UEs. A Policy Control Function (PCF) 4 may support a unified policy framework to govern the network behavior. Specifically, the PCF 4 may provide Policy and Charging Control (PCC) rules to the Policy and Charging Enforcement Function (PCEF), that is, an SMF 5/User Plane function (UPF) 6 that may enforce policy and charging decisions according to provisioned Policy and Charging Control (PCC) rules. The SMF 5 may support different functionalities, e.g., session establishment, modify and release, and policy related functionalities such as termination of interfaces towards policy control functions, charging data collection, support of charging interfaces and control and coordination of charging data collection at the UPF 6. Specifically, the SMF 5 may receive the PCC rules from the PCF 4 and may configure the UPF 6 accordingly through an N4 7 reference point, Packet Flow Control Protocol (PFCP) protocol. The UPF 6 may support handling of user plane traffic based on the rules received from the SMF 5, e.g., packet inspection through Packet Detection Rules (PDRs) and different enforcement actions such as, e.g., traffic steering, Quality of Service (QOS), Charging/Reporting through Forwarding Action Rules (FARs), QoS

Enforcement Rules (QERs), and/or Usage Reporting Rule (URRs). The PCF 4 may provide policy rules to a UE 8 through the AMF 9. The AMF 9 may manage access of the UE 8, for example, when the UE 8 may be connected through different access networks, and mobility aspects of the UE 8. Also depicted in FIG. 1 is a Network Slice Selection Function (NSSF) 10, Network Repository Function (NRF) 11, an Authentication Server Function (AUSF) 12, a Radio Access Network (RAN) 13, and a Data Network (DN) 14. Each of the NSSF 10, the NEF 2, the NRF 11, the PCF 4, the UDM 3, the AF 1, the AUSF 12, the AMF 9, the SMF 5, the UE 8, the RAN 13, the UPF 6 and the DN 14 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23, N1 24, and N2 25. The RAN 13 may have an interface N3 26 with the UPF 6, and the UPF 6 may have an interface N6 27 with the DN 14.

3GPP TS 23.501, v. 17.2.0 and 23.502, v. 17.2.1 lay down an event exposure architecture for 5GC, where a few network functions, such as UDM, AMF, SMF, and PCF may implement an interface to exfiltrate data to interested parties. This may be understood to be the so-called Event Exposure technology, which may be understood to be based on a consumer making subscriptions to certain UE-related events at a Network Function, and receiving subsequent notifications related to that subscribed event.

A first scenario within this technology is that described in 3GPP TS 23.502, v. 17.2.1,which in clause 4.15.3.2.3, defines a mechanism whereby a subscriber of Event Exposure, such as NEF, may subscribe, at the UDM, to events related to access, mobility, and session, for a particular UE. FIG. 2, which is reproduced herein from 3GPP TS 23.502, v. 17.2.1, illustrates the concept. At Step 1, the AF may send an Nnef_Event Exposure_Subscribe/Unsubscribe Request to the NEF. The NEF then, in Step 2, sends a Nudm_EventExposure_ Subscribe/Unsubscribe Request to the UDM. At Step 3a, the UDM sends in turn a Namf_EventExposure Subscribe/Unsubscribe Request to the AMF. The AMF then sends a Namf_EventExposure Subscribe/Unsubscribe Request to the UDM at Step 3b. The UDM also sends an Nsmf_EventExposure Subscribe/Unsubscribe Request to the SMF at Step 3c, and the SMF then sends back a Nsmf_EventExposure Subscribe/Unsubscribe Response to the UDM in step 3d. 3GPP TS 23.502, v. 17.2.1 highlights the following relevant steps. At Step 4, in a conditional manner, the UDM may acknowledge the execution of Nudm_EventExposure_Subscribe. If the subscription is applicable to a group of UE(s) and the Maximum number of reports is included in the Event Report information in step 1, the Number of UEs, including all group member UEs irrespective of their registration state, may be included in the acknowledgement. The maximum number of reports may be understood as the maximum number of reports after which the event subscription may cease. When the subscription is applied to a group of devices, e.g., UE(s), the parameter may be applied to each individual member device, e.g., UE. If the AMF or the SMF provide the first event report in step 3b or step 3d, the UDM may include the event report in the acknowledgement. At Step 5, the NEF sends a Nnef_EventExposure Subscribe/Unsubscribe Response to the AF. At Steps 6a-6b, in a conditional manner depending on the Event, the UDM, depending on the Event, may detect that the event occurs and may send the event report, by means of a Nudm_EventExposure_Notify message to the associated notification endpoint of the NEF, along with a time stamp. The NEF may store the information in the UDR along with the time stamp using either Nudr_DM_Create or Nudr_DM_Update service operation as appropriate. If Nudm_EventExposure_Subscribe with update is received in Step 2 indicating removal of event notification subscription for certain UEs in a group of UEs for which there is an event notification subscription or addition of certain new UEs in the group, the UDM may be required to cancel the subscription to the event notification for the impacted UEs or add the impacted UEs in the group based on the operation of Group Management. If Maximum number of Reports is applied, the UDM may be required to set the number of reports of the indicated UE(s) to Maximum Number of Reports for the events monitored by the UDM in order to stop reporting events monitored by the UDM for the indicated UEs. At Steps 6c-6d, in a conditional manner depending on the Event, the AMF may detect the event occurs and may send the event report, by means of Namf_EventExposure_Notify message to the associated notification endpoint of the NEF along with the time stamp. The NEF may store the information in the UDR along with the time stamp using either Nudr_DM_Create or Nudr_DM_Update service operation as appropriate. If the AMF has a maximum number of reports stored for the UE or the individual member UE, the AMF may be required to decrease its value by one for the reported event. If the Namf_EventExposure_Subscribe with update is received in step 3a indicating removal of event notification subscription for certain UEs in a group of UEs for which there is an event notification subscription or addition of certain new UEs in the group, the AMF may be required to stop the event notification for the impacted UEs or start the event notification for the impacted UEs based on the operation of Group Management. If the Maximum number of Reports is applied, the AMF may be required to set the number of reports of the indicated UE(s) to Maximum Number of Reports. For both step 6a and step 6c, when the maximum number of reports is reached and if the subscription is applied to a UE, the NEF may unsubscribe the monitoring event(s) to the UDM and the UDM may unsubscribe the monitoring event(s) to the AMF serving for that UE. For both step 6a and step 6c, when the maximum number of reports is reached for an individual group member UE, the NEF may use the Number of UEs received in step 4 and the Maximum number of reports to determine if reporting for the group is complete. If the NEF determines that reporting for the group is complete, the NEF may unsubscribe the monitoring event(s) to the UDM and the UDM may unsubscribe the monitoring event(s) to all AMF(s) serving the UEs belonging to that group. It may be noted that if an expiry time as specified in clause 6.2.6.2.6 of TS 29.518, v. 17.4.9 [19] is not included in the event subscription, then the lifetime of the event subscription may need to be controlled by other means, as there may be understood to be no time based cancellation at all, even if any group member UEs fail to register. When the Maximum duration of reporting expires in the NEF, the UDM and the AMF, then each of these nodes may be required to locally unsubscribe the monitoring event. As it may be understood from the previous description, when the UDM receives a subscription for event exposure for a group of UE, it may be required to provide the number of UEs associated to this group. This information may be later on used to determine the maximum number of reports allowed for this group.

If for whatever reason, any UE is deleted or added to the group, the UDM may have to notify the AMF about this change.

TS 29.503, v. 17.4.0 specifies how this maximum number of reports may be calculated. FIG. 3 shows the details about the subscription operation and how the number of UEs information may be required to be used. At Step 1, an NF service consumer may subscribe to an Event Exposure at the UDM by sending a POST message comprising “/{ueIdentity}/ee-subscriptions (EeSubscription)”. 3GPP TS 29.503, v. 17.4.0 highlights the following relevant steps. At Step 2a, on success, the UDM may respond with “201 Created”, with the message body containing a representation of the created subscription, here “EeSubscription”. The Location Hypertext Transfer Protocol (HTTP) header may be required to contain the Uniform Resource Identifier (URI) of the created subscription. If the event subscription was for a group of UEs, the “maxNumOfReports” in the “reportingOptions” IE may be required to be applicable to each UE in the group. The maximum number of reports may be applied to each member device, e.g., UE, of the group. For example, if an event subscription is created for a group with 5 members and the maximum number of reports is requested to be 10, the event subscription may be terminated when reaching 50 reports/notifications. Additionally, the UDM may be required to return the number of UEs in that group in the “numberOfUes” IE.

The NF service consumer may be required to keep track of the maximum number of reports reported for each UE in the event report and, when the “maxNumOfReports*numberOfUes” limit is reached, the NF service consumer may be required to initiate the unsubscription of the notification towards the UDM.

If the event subscription was for a list events, the “maxNumOfReports” in the “reportingOptions” IE may be required to be applicable to each event. That is, there may be a number of events defined in 5GC that may be detected and reported upon event subscription request, e.g., roaming status, communication failure, etc. The event subscription may be requested for one or more events. The maximum number of reports, if included in the subscription request, may be understood to apply to each subscribed event. The NF service consumer may be required to keep track of the maximum number of reports reported for each event in the event report and, when “maxNumOfReports*number of events” limit is reached, the NF service consumer may be required to initiate the unsubscription of the notification towards the UDM.

The response, based on operator policy, may contain the expiry time, as determined by the UDM, after which the subscription may be understood to become invalid. Before the subscription is going to expire, if the NF Service Consumer wants to keep receiving notifications, it may be required to modify the subscription in the UDM with a new expiry time. The NF Service Producer may be required to not provide the same expiry time for many subscriptions in order to avoid all of them expiring and recreating the subscription at the same time. If the expiry time is not included in the response, the NF Service Consumer may be required to not associate an expiry time for the subscription.

If the indication on whether the subscription applies also to the Evolved Packet Core (EPC) is included in the request, the response may be required to include the indication on whether the subscription was also successful in the EPC domain. An AF may send an event subscription to the NEF indicating to apply the subscription also in the EPC in addition to the 5GC. In that case, the NEF may indicate so when subscribing in the UDM. Then UDM may handle the event subscription in the 5GC and may request the Home Subscriber Server (HSS) to apply the event subscription in the EPC. The HSS may reply to the UDM the result of the subscription request in the EPC, and the UDM may include it in the response to the NEF.

This description is stating that the NEF, the UDM NF Consumer in this case, may be required to receive a maximum number of reports equal to “maxNumberOfReports” multiplied by “number of UEs” before sending the unsubscription to UDM, considering that all expected reports have been received.

The information about the UEs belonging to a group may be kept in the UDR Network Function as part of the Group Identifiers resource, as it is described in chapter 5.2.33 in TS 29.505, v. 17.5.0 [4]. Table 1 shows the information that may be stored in the UDR related to this resource, where “P” indicates the presence of a condition of the data structure, where “M” indicates Mandatory, “C” indicates Conditional, and “O” indicates Optional. Cardinality indicates the allowed number of occurrence of data type:

TABLE 1

| Attribute | | | Cardi- | |
|---|---|---|---|---|
| name | Data type | P | nality | Description |
| extGroupId | ExtGroupId | C | 0 . . . 1 | This IE may be required to |
| | | | | contain the External Group |
| | | | | ID associated to the |
| | | | | provided Internal Group |
| | | | | ID. |
| intGroupId | GroupId | C | 0 . . . 1 | This IE may be required to |
| | | | | contain the Internal Group |
| | | | | ID associated to the |
| | | | | provided External Group |
| | | | | ID. |
| ueIdList | array(UeId) | C | 1 . . . N | This IE may be required to |
| | | | | contain a list of the UE |
| | | | | identifiers that belong to |
| | | | | the provided Internal/ |
| | | | | External Group ID if they |
| | | | | are required. |
| allowedAfIds | array(string) | O | 1 . . . N | A list of Application |
| | | | | Function Identifiers |
| | | | | authorized to retrieve this |
| | | | | Identities lists. |
| | | | | The absence of this IE may |
| | | | | indicate that any AF is |
| | | | | allowed to retrieve them. |

As it may be observed in Table 1, a group may contain the list of UEs associated to a group together with its group identifiers, internal and external.

It is true that TS 29.503, v. 17.4.0 is not yet updated to include a notification procedure to inform the AMF that the number of UEs in a group has changed. However, it may be assumed that it may be included as it is mandated by 23.502, v. 17.2.1.

A second scenario related to the Event Exposure technology is that described in 3GPP TS 23.502, v. 17.2.1, which in chapter 4.5.2 states that whenever the user profile is changed and the AMF has subscribed to user data changes, the UDM may be required to inform the AMF about the new profile data.

Whenever the user profile is changed for a user in the UDM/UDR, and the changes affect the user profile in the AMF, the UDM may be required to notify these changes to the affected AMF by the means of invoking Nudm_SDM_Notification service operation. Then the AMF may add or modify the user profile.

TS 29.503, v. 17.4.0 defines the user profile in the “AccesAndMobilityData” Information Element. Table 2 depicts the information included in Access and Mobility Subscription Data of a UE in 5GC. As part of this structure, a list of identifiers of group and Internal Group Id may be included if the UE belongs to one or several Event Exposure or 5G VN groups.

TABLE 2

| Attribute name | Data type | P | Cardinality | Description |
|---|---|---|---|---|
| supportedFeatures | SupportedFeatures | O | 0 . . . 1 | See clause 6.1.8 |
| Gpsis | array(Gpsi) | | 0 . . . N | List of Generic Public Subscription |
| | | | | Identifier; see 3GPP TS 29.571 |
| internalGroupIds | array(GroupId) | O | 1 . . . N | List of internal group identifier; |
| | | | | see 3GPP TS 23.501 clause 5.9.7 |
| sharedVnGroupDataIds | map(SharedDataId) | O | 1 . . . N | A map of identifiers of shared 5G VN |
| | | | | group data (list of key-value pairs |
| | | | | whereGroupId serves as key; see |
| | | | | clause 6.1.6.1). |
| | | | | This attribute may be only applicable |
| | | | | to the Nudm interface and may be |
| | | | | required to not be included over |
| | | | | the Nudr interface. |
| hssGroupId | NfGroupId | O | 0 . . . 1 | Identity of the HSS group associated |
| | | | | with the subscription, which may |
| | | | | be used by the UDM in discovering |
| | | | | the HSS; see 3GPP TS 29.510, v. |
| | | | | 17.4.0. |
| | | | | This attribute may be included if the |
| | | | | coreNetworkTypeRestrictions does not |
| | | | | indicate a value of “EPC”. |
| | | | | This attribute may be only applicable |
| | | | | to the Nudr interface and may be |
| | | | | required to not be included over |
| | | | | the Nudm interface. |
| subscribedUeAmbr | AmbrRm | O | 0 . . . 1 | |
| Nssai | Nssai | O | 0 . . . 1 | Network Slice Selection Assistance |
| | | | | Information |
| ratRestrictions | array(RatType) | O | 0 . . . N | List of RAT Types that are restricted |
| | | | | in 5GC and EPC; see 3GPP TS 29.571, v. |
| | | | | 17.4.0 [7] |
| . . . | | | | |

Whenever a UE may be added or removed from a group, th Subscriber Data Management (SDM) Notification mentioned above may be required to be triggered including, updating, or removing the internalGroupIds list.

Existing methods for such a notification, relating to a group of UEs in a communications system, may involve high overhead and impair the effective functioning of the communications system.

### SUMMARY

As part of the development of embodiments herein, one or more challenges with the existing technology will first be identified and discussed.

A first problem that may be identified in existing methods is that whenever a UE may be removed or included in a group, the maximum number of reports to be received for this group may be required to be recalculated and the UDM NF consumers, e.g., the AMF, may be required to be notified about the introduction or removal of this UE in this group. However, there is not an implicit or explicit notification mechanism in the UDR to notify about changes in the list of UEs associated to a group. The only way to do that is by modifying and hence notifying the NEF about each and every affected user one by one, as it is shown in FIG. 4.

A second problem that may be identified in existing methods is that the modification of the membership of a group, adding or removing UEs, or even the complete removal of the group in the system, may imply a massive SDM notification sending towards the AMF or the SMF, as it is shown in FIG. 5.

The purpose of embodiment herein may be understood to be reducing the number of notifications sent by the UDR, but also towards the network.

Embodiments herein may be able to be used to notify about similar changes related to other procedures, such as 5G Virtual Network (VN) Group Data provisioning, as specified respectively in section 4.15.6.3 in 3GPP TS 23.502, v. 17.3.0.

According to the foregoing, it is an object of embodiments herein to improve the handling of information in a communications system.

According to a first aspect of embodiments herein, the object is achieved by a computer-implemented method, performed by a first node. The method is for handling information. The first node operates in a communications system. The first node sends a first indication to a second node operating in the communications system. The first indication indicates a capability of the first node to receive a notification indicating a change to information. The information pertains to an integrity of a group of devices operating in the communications system. The first node also receives, based on the sent first indication, a first notification from a third node operating in the communications system. The first notification indicates a first change to the information pertaining to the group of devices. The first change affects two or more of the devices in the group of devices.

According to a second aspect of embodiments herein, the object is achieved by a computer-implemented method, performed by the second node. The method is for handling information. The second node operates in the communications system. The second node receives the first indication from the first node operating in the communications system. The first indication indicates the capability of the first node to receive the notification indicating the change to the information. The information pertains to the integrity of the group of devices operating in the communications system. The second node also sends, based on the received first indication, another indication to the third node operating in the communications system. The another indication indicates the capability of the first node.

According to a third aspect of embodiments herein, the object is achieved by a computer-implemented method, performed by the third node. The method is for handling information. The third node operates in the communications system. The third node sends a fourth indication to the second node operating in the communications system. The fourth indication requests discovery of the first node having the capability to receive the notification indicating the change to the information pertaining to the integrity of the group of devices operating in the communications system. The third node also receives, based on the sent fourth indication, a fifth indication from the second node. The fifth indication indicates the capability of the first node.

According to a fourth aspect of embodiments herein, the object is achieved by the first node, for handling information. The first node is configured to operate in the communications system. The first node is further configured to send the first indication to the second node configured to operate in the communications system. The first indication is configured to indicate the capability of the first node to receive the notification configured to indicate the change to the information. The information is configured to pertain to the integrity of the group of devices configured to operate in the communications system. The first node is further configured to receive, based on the first indication configured to be sent, the first notification from the third node configured to operate in the communications system. The first notification is configured to indicate the first change to the information configured to pertain to the group of devices. The first change is configured to affect two or more of the devices in the group of devices.

According to a fifth aspect of embodiments herein, the object is achieved by the second node, for handling information. The second node is configured to operate in the communications system. The second node is further configured to receive the first indication from the first node configured to operate in the communications system. The first indication is configured to indicate the capability of the first node to receive the notification configured to indicate the change to information configured to pertain to the integrity of the group of devices configured to operate in the communications system. The second node is further configured to send, based on the first indication configured to be received, the another indication to the third node configured to operate in the communications system. The another indication is configured to indicate the capability of the first node.

According to a sixth aspect of embodiments herein, the object is achieved by the third node, for handling information. The third node is configured to operate in the communications system. The third node is further configured to send the fourth indication to the second node configured to operate in the communications system. The fourth indication is configured to request discovery of the first node having the capability to receive the notification configured to indicate the change to the information configured to pertain to the integrity of the group of devices configured to operate in the communications system. The third node is further configured to receive, based on the fourth indication configured to be sent, the fifth indication from the second node. The fifth indication is configured to indicate the capability of the first node.

By sending the first indication, the first node may enable the second node to know that the first node may receive the notification about the change to the information pertaining to the integrity of the group of devices. This may in turn enable the first node to be discoverable by the third node, via the second node sending the another indication to the third node. When the third node may send the fourth indication to the second node and then discover the first node in the second node by receiving the another indication, also referred to herein as the fifth indication, the third node may be enabled to understand that the first node may require receiving group based related notifications instead of receiving individual notifications for each device inside the group of devices. The third node may then be enabled to know it may send the first notification to the first node.

By receiving the first notification notifying of the first change, wherein the first change affects two or more of the devices in the group of devices, the first node may be enabled to become aware of the occurrence of the first change affecting the two or more devices of the group of devices in a single notification, instead of in a plurality of individual notifications, one for each of the two or more devices having undergone a change. Hence, overhead may be reduced, and resources may be used more efficiently in the communications system.

Furthermore, the number of notifications used to report changes to the group of devices may be lower, hence, any subscription to receive notifications of such changes may no longer need to be cancelled as rapidly as it would otherwise have to be, due to a massive number of individual notifications. This may be understood to apply whenever the subscription may have an associated maximum number of notifications.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture, according to existing methods.

FIG. 2 is a schematic diagram illustrating a subscription to event exposure at a UDM, according to existing methods.

FIG. 3 is a schematic diagram illustrating details of a subscription to event exposure at a UDM, according to existing methods.

FIG. 4 is a schematic diagram illustrating an example of adding several users to a group, according to existing methods.

FIG. 5 is a schematic diagram illustrating an example of a removal of a group, according to existing methods.

FIG. 6 is a schematic diagram illustrating a non-limiting example of a communications system, according to embodiments herein.

FIG. 7 is a flowchart depicting embodiments of a method in a first node, according to embodiments herein.

FIG. 8 is a flowchart depicting embodiments of a method in a second node, according to embodiments herein.

FIG. 9 is a flowchart depicting embodiments of a method in a third node, according to embodiments herein.

FIG. 10 is a schematic diagram depicting a non-limiting example of signalling between nodes in a communications system, according to embodiments herein.

FIG. 11 is a schematic diagram depicting another non-limiting example of signalling between nodes in a communications system, according to embodiments herein.

FIG. 12 is a schematic diagram depicting yet another non-limiting example of signalling between nodes in a communications system, according to embodiments herein.

FIG. 13 is a schematic diagram depicting a further non-limiting example of signalling between nodes in a communications system, according to embodiments herein.

FIG. 14 is a schematic block diagram illustrating two non-limiting examples, a) and b), of a first node, according to embodiments herein.

FIG. 15 is a schematic block diagram illustrating two non-limiting examples, a) and b), of a second node, according to embodiments herein.

FIG. 16 is a schematic block diagram illustrating two non-limiting examples, a) and b), of a third node, according to embodiments herein.

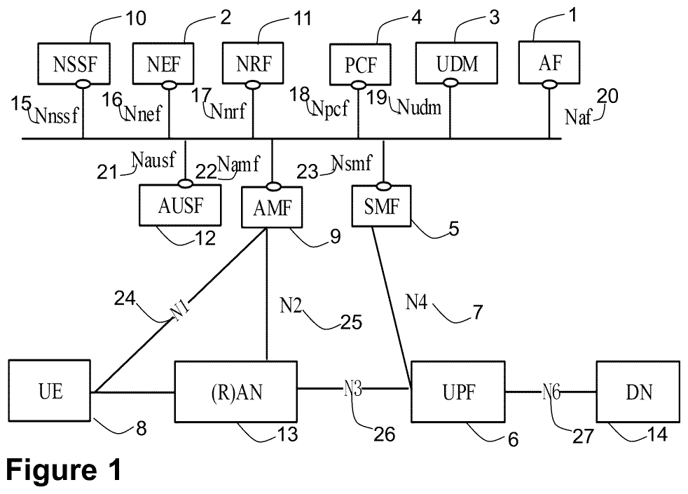

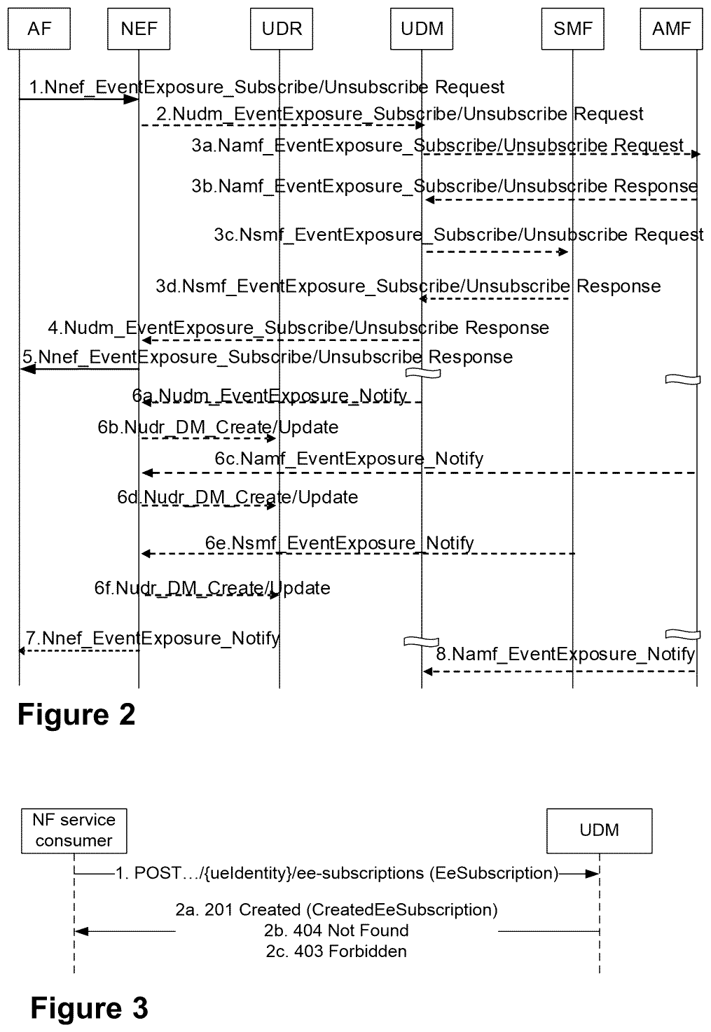

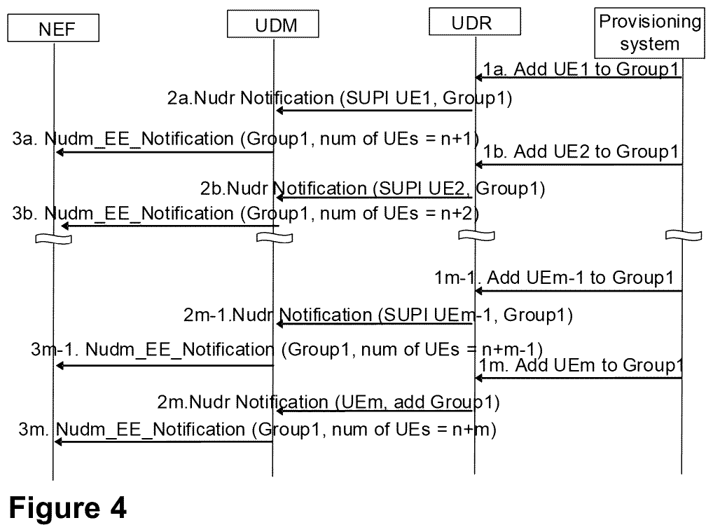

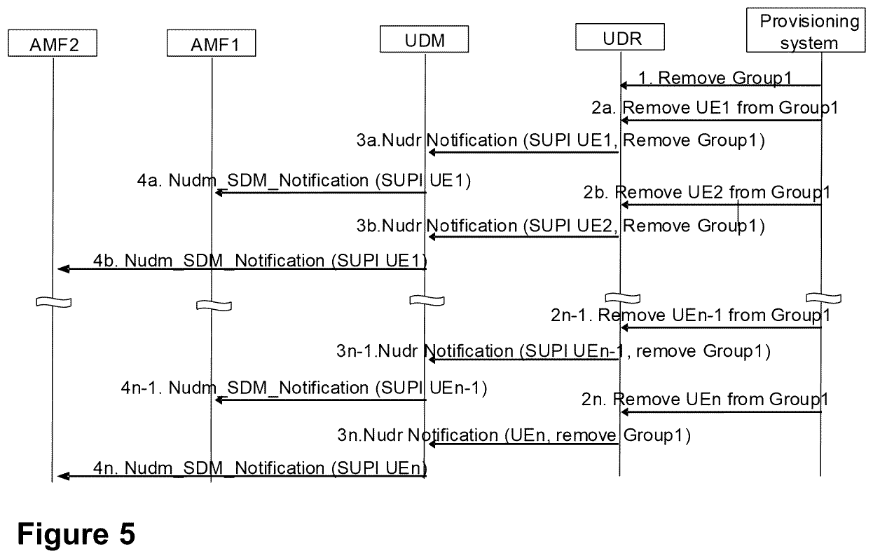

### DETAILED DESCRIPTION

Certain aspects of the present disclosure and their embodiments address one or more of the challenges identified with the existing methods and provide solutions to the challenges discussed.

Embodiments herein may relate to a method of notifying event exposure group updates in a communications system, e.g., in 5GC.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

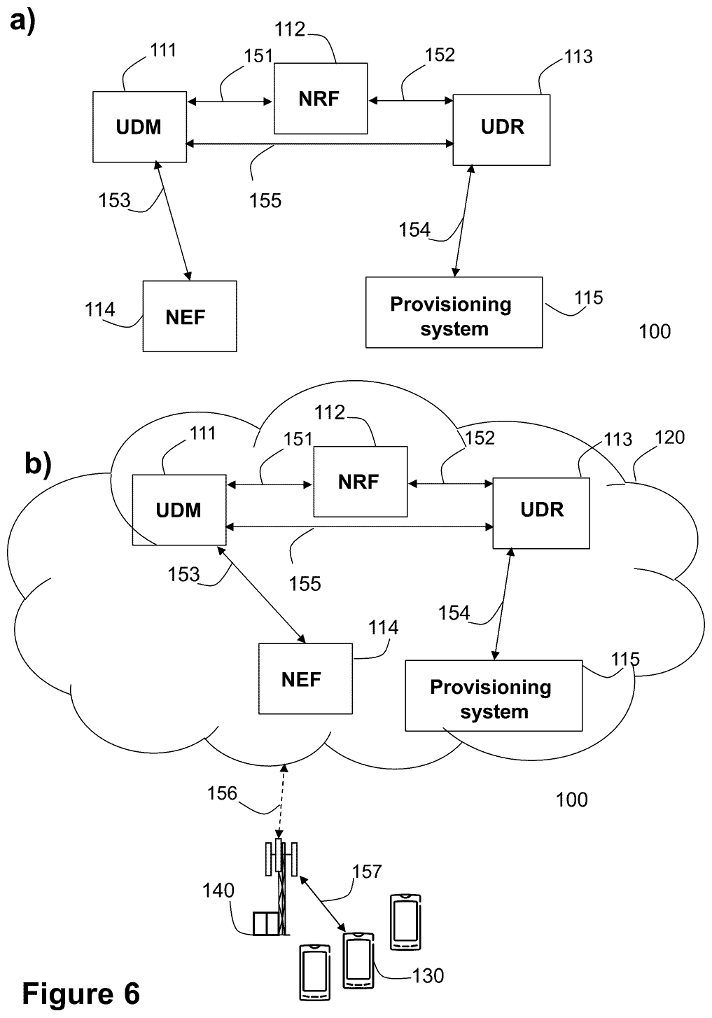

FIG. 6 depicts two non-limiting examples, in panels “a” and “b”, respectively, of a communications system 100, in which embodiments herein may be implemented. In some example implementations, such as that depicted in the non-limiting example of FIG. 6a, the communications system 100 may be a computer network. In other example implementations, such as that depicted in the non-limiting example of FIG. 6b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices, with serving beams.

In some examples, the telecommunications system may for example be a network such as a 5G system, or a newer system supporting similar functionality. The telecommunications system may also support other technologies, such as a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band, Wideband Code Division Multiple Access (WCDMA), UTRA TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802. 15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, a third node 113, a fourth node 114, and a fifth node 115, are depicted in FIG. 6. It may be understood that the communications system 100 may comprise more nodes than those represented on FIG. 6.

Any of the first node 111, the second node 112, the third node 113, the fourth node 114 and the fifth node 115 may be understood, respectively, as a first computer system, a second computer system, a third computer system, a fourth computer system and a fifth computer system. In some examples, any of the first node 111, the second node 112, the third node 113, the fourth node 114 and the fifth node 115 may be implemented as a standalone server in e.g., a host computer in the cloud 120, as depicted in the non-limiting example depicted in panel b) of FIG. 6. Any of the first node 111, the second node 112, the third node 113, the fourth node 114 and the fifth node 115 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113, the fourth node 114 and the fifth node 115 may also be implemented as processing resources in a server farm.

Any of the first node 111, the second node 112, the third node 113, the fourth node 114 and the fifth node 115 may be independent and separate nodes. In some examples, any of the first node 111, the second node 112, and the fifth node 115 may be co-localized or be the same node.

In some examples of embodiments herein, the first node 111 may be understood as a node that may have a capability to handle notifications about group data for a device. As depicted in the non-limiting example of FIG. 6, a non-limiting example of the first node 111, wherein the communications system 100 may be a 5G network, may be UDM. In other examples, not depicted in FIG. 6, the first node 111 may be an AMF.

The second node 112 may be a node having a capability t to store and maintain addresses for notifications registered by some nodes. In some particular examples wherein the communications system 100 may be a 5G network, the second node 112 may be an NRF operating in the communications system 100. This is depicted in the non-limiting example of FIG. 6 for illustrative purposes only.

The third node 113 may be a node having a capability to store data, e.g., grouped into distinct collections of subscription-related information, such as subscription data, policy data, structured data for exposure, and application data. In some particular examples, such as in those wherein the first node 111 may be a UDM, the third node 113 may be a UDR, e.g., in a 5G network. In other examples wherein the first node 111 may be an AMF, the third node 113 may be a UDR.

The fourth node 114 may be a node having a capability to handle subscription to events in the communications system 100 and e.g., manage the number of reports allowed in a group of devices. In the non-limiting example of FIG. 6, the fourth node 114 is a NEF.

The fifth node 115 may be a node having a capability to provision and/or define subscription data related to a group of devices. In some particular examples wherein the communications system 100 may be a 5G network and wherein the first node 111 may be a UDM, the fifth node 115 may be a Provisioning system. This is depicted in the non-limiting example of FIG. 6 for illustrative purposes only. In other examples wherein the first node 111 may be an AMF, the fifth node 115 may be a UDR or a NEF.

The communications system 100 may comprise a group of devices 130 represented in FIG. 6 with three devices for illustration purposes only. It may be understood that the group of devices 130 may comprise fewer or additional devices. Any of the devices in the group of devices 130 may be also known as e.g., user equipment (UE), a wireless device, mobile terminal, wireless terminal and/or mobile station, mobile telephone, cellular telephone, or laptop with wireless capability, an Internet of Things (IoT) device, a sensor, or a Customer Premises Equipment (CPE), just to mention some further examples. Any of the devices in the group of devices 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the devices in the group of devices 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In the non-limiting example of FIG. 6, the group of devices 130 may be a group of UEs, which may be understood to be for illustrative purposes only.

The communications system 100 may comprise one or more radio network nodes, whereof a radio network node 140 is depicted in FIG. 6b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The second node 112 may communicate with the third node 113 over a second link 152, e.g., a radio link or a wired link. The first node 111 may communicate with the fourth node 114 over a third link 153, e.g., a radio link or a wired link. The third node 113 may communicate, directly or indirectly, with the fifth node 115 over a fourth link 154, e.g., a radio link or a wired link. The third node 113 may communicate, directly or indirectly, with the first node 111 over a fifth link 155, e.g., a radio link or a wired link. The radio network node 140 may communicate, directly or indirectly with the cloud 120, e.g., with one or more nodes comprised in the communications system 100, such as with the first node 111 in embodiments wherein the first node 111 may be an AMF, via a sixth link 156, e.g., a radio link or a wired link. The radio network node 140 may communicate with the device 130 over a seventh link 157, e.g., a radio link.

Any of the respective first link 151, the second link 152, the third link 153, the fourth link 154, the fifth link 155, the sixth link 156 and/or the seventh link 157 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 6.

In general, the usage of “first”, “second”, “third”, “fourth”, “fifth”, “sixth” and/or “seventh” herein may be understood to be an arbitrary way to denote different elements or entities and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

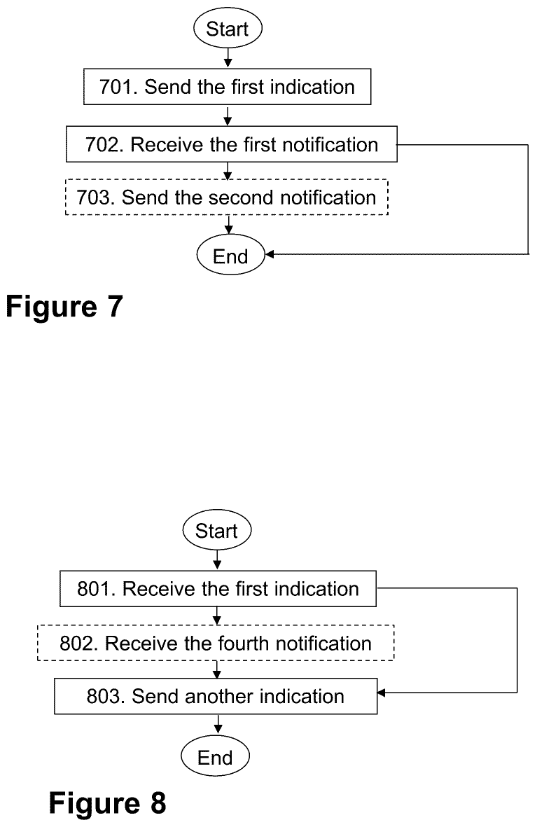

Embodiments of a computer-implemented method, performed by the first node 111, will now be described with reference to the flowchart depicted in FIG. 7. The method may be understood to be for handling information. The first node 111 operates in the communications system 100.

Several embodiments are comprised herein. The method may comprise one or more of the following actions. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 7.

In FIG. 7, optional actions are represented with dashed lines.

### Action 701

In this Action 701, the first node 111 sends a first indication to the second node 112 operating in the communications system 100. The first indication indicates a capability of the first node 111 to receive a notification indicating a change to information pertaining to an integrity of a group of devices 130 operating in the communications system 100. The group of devices 130 may have been created in the communications system 100, e.g., as described in TS 23.502, v. 17.3.0.

The sending of the first indication may be performed e.g., via the first link 151.

The integrity of the group of devices 130 may be understood to refer to the constituents of the group of devices 130, that is, to refer to its members. The information pertaining to the integrity of the group of devices 130 may therefore be understood as “group data”. The change may be one of: a) an addition or removal of two or more devices from the group of devices 130, e.g., removal or addition of several UEs within a group of UEs, b) a removal of the group of devices 130, that is, removal of the complete group, and c) a change to group data of a virtual network, e.g., 5G VN data. The change may affect two or more of the devices in the group of devices 130. That is, the change may be a group data change.

In some embodiments, the first indication may further indicate an address to which the notification may be sent. The address may be referred to as a group data change notification address. The first node 111 may provide a default notification address to the second node 112 as part of its Network Function profile to state the first node 111 may be able to receive group data change related notifications. If the address is then provided as part of the NF Profile, the second node 112 may understand that the first node 111 may require receiving the notification, e.g., that is, a group based related notification, instead of receiving individual notifications for each device inside the group of devices 130.

The sending of the first indication in this Action 701 may be performed upon registration of the first node 111 in the second node 112.

In some embodiments, the first node 111 may be a UDM node and the second node 112 may be an NRF. In some of such embodiments, the first indication may be an Nnrf Register message, and the change may be one of: an addition or removal of devices from the group of devices 130, and the removal of the group of devices 130.

In other embodiments, the first node 111 may be an AMF node and the second node 112 may be the NRF. In some of such embodiments, the first indication may be an Nnrf Register message, and the change may be one of: the addition or removal of devices from the group of devices 130, the removal of the group of devices 130, and the change to the group data of the virtual network.

By sending the first indication in this Action 701, the first node 111 may enable the second node 112 to know the first node 111 may receive the notification about the change to the information pertaining to the integrity of the group of devices 130. Furthermore, the first node 111 may enable the address to be discoverable by the third node 113, and thereby be enabled to receive the notification at the registered address. When the third node 113 may discover a consumer of the third node 113 such as the first node 111 in the second node 112, if the address, that is, the group data change notification address is provided, for example, as part of the NF Profile, the third node 113 may then be enabled to understand that the consumer of the third node 113 may require receiving group based related notifications instead of receiving individual notifications for each device inside the group of devices 130.

In some particular embodiments, this may mean that when the UDR may discover a UDR consumer, e.g., the UDM, in the NRF, if the group data change notification address is provided as part of the NF Profile, it may then understand that the UDR consumer may require receiving group based related notifications instead of receiving individual notifications for each UE inside the group. In other examples, this may mean that when the UDM may discover an UDM consumer, e.g., the AMF, in the NRF, if the group membership notification address is provided as part of the NF Profile, the UDM may then understand that the UDM consumer may require receiving group based related notifications instead of receiving individual notifications for each UE inside the group of devices 130.

### Action 702

In this Action 702, the first node 111 may receive, based on the sent first indication, a first notification from the third node 113 operating in the communications system 100. The first notification indicates a first change to the information pertaining to the group of devices 130. The first change affects two or more of the devices in the group of devices 130. Accordingly, the notification may be a group based related notification.

The receiving may be performed e.g., via the fifth link 155.

In some of the embodiments wherein the first indication may have further indicated the address to which the notification may be sent, the receiving in this Action 702 may be at the indicated address.

If the first node 111 has registered the address, that is, the group data change default notification address, upon group data modification, the third node 113 may be able to notify the first node 111 about this change in just one query using the default notification address registered by the first node 111, e.g., a UDR NF Consumer such as e.g., the UDM. This notification may comprise the information updated related to this group.

The notification may be a new notification such as e.g., a GROUP UPDATE or GROUP_REMOVAL.

In some embodiments, the first node 111 may be a UDM, the second node 112 may be an NRF, and the third node 113 may be a UDR.

In some of the embodiments wherein the first node 111 may be the UDM, the second node 112 may be the NRF, and the third node 113 may be the UDR, the first indication may be an Nnrf Register message, the first notification may be a Nudr_Notification message, and the change may be one of: the addition or removal of devices from the group of devices 130, and the removal of the group of devices 130.

In other embodiments, the first node 111 may be an AMF, the second node 112 may be an NRF, and the third node 113 may be a UDM.

In some of these other embodiments wherein the first node 111 may be the AMF, the second node 112 may be the NRF, and the third node 113 may be the UDM, the first indication may be an Nnrf Register message, the first notification may be a Nudm_SDM_Notification message, and the change may be one of: the addition or removal of devices from the group of devices 130, the removal of the group of devices 130, and the change to group data of the virtual network.

By receiving the first notification in this Action 702, the first node 111 may be enabled to become aware of the occurrence of the first change affecting the two or more devices of the group of devices 130 in a single notification, instead of in a plurality of individual notifications, one for each of the two or more devices having undergone a change.

### Action 703

The reception of the first notification, that is, of the group data change notification in the first node 111, may trigger specific network procedures such as notifying the fourth node 114, e.g., the NEF, about the change, that is, the group membership change or the updating of the UE profile associated to the modified group in e.g., the AMF/SMF.

In this Action 703, the first node 111 may send, based on the received first notification, a second notification to the fourth node 114 operating in the communications network 100. The second notification may indicate the first change.

This Action 703 may be performed in embodiments wherein the change may be the addition or removal of the two or more devices from the group of devices 130.

The sending of the second notification in this Action 703 may be performed e.g., via the third link 153.

In some embodiments wherein the change may be the addition or removal of devices from the group of devices 130, the second notification may comprise a second indication of a first number of devices remaining in the group of devices 130 after the addition or removal of the two or more devices from the group of devices 130.

If the fourth node 114 has created an event exposure subscription, the first node 111 may be able to, upon group data change notification received from the third node 113, notify the fourth node 114 about the group data change in just one query using, for example, an existing Event Exposure notification to notify, e.g.: a) updating the number of devices within the group of devices 130 to calculate the maximum number of reports allowed for this group of devices 130, when devices may be added or removed, or b) subscription revocation upon removal of the complete group.

In some embodiments, the first node 111 may be a UDM, the second node 112 may be an NRF, the third node 113 may be a UDR and the fourth node 114 may be an NEF.

In some of the embodiments wherein the first node 111 may be the UDM, the second node 112 may be the NRF, and the third node 113 may be the UDR, and the fourth node 114 may be the NEF, the first indication may be an Nnrf Register message, the first notification may be a Nudr_Notification message, the second notification may be a Nudm_EventExposure_Notify message, and the change may be one of: the addition or removal of devices from the group of devices 130, and the removal of the group of devices 130.

The second notification may be, for example, Nudm_EventExposure_Notify (GROUP MEMBERSHIP UPDATE, Group1, number of UEs=n+m/n−m).

By sending the second notification to the fourth node 114 in this Action 703, the first node 111 may be enabled to notify the fourth node 114 about the group data change in just one query using, thereby saving overhead in notifying the occurrence of events relating to a group of devices 130 in the communications system 100.

Embodiments of a computer-implemented method performed by the second node 112, will now be described with reference to the flowchart depicted in FIG. 8. The method may be understood to be for handling information. The second node 112 operates in the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 8, optional actions are depicted with dashed lines.

The detailed description of some of the following corresponds to the same references provided above, in relation to the actions described for the first node 111 and will thus not be repeated here to simplify the description. For example, in some embodiments, the first node 111 may be a UDM, the second node 112 may be an NRF, and the third node 113 may be a UDR. In other embodiments, the first node 111 may be an AMF, the second node 112 may be an NRF, and the third node 113 may be a UDM.

### Action 801

In this Action 801, the second node 112 receives the first indication from the first node 111 operating in the communications system 100. The first indication indicates the capability of the first node 111 to receive the notification indicating the change to the information pertaining to the integrity of the group of devices 130 operating in the communications system 100.

The receiving in this Action 801 may be performed e.g., via the first link 151.

As described earlier, the change may be one of: a) the addition or removal of two or more devices from the group of devices 130, b) the removal of the group of devices 130, and c) the change to the group data of the virtual network, e.g., a 5G VN. The change may affect two or more of the devices in the group of devices 130.

In some embodiments, the first indication may further indicate the address to which the notification may be sent.

In some embodiments, the first node 111 may be the UDM node and the second node 112 may be the NRF. In some of such embodiments, the first indication may be the Nnrf Register message, and the change may be one of: the addition or removal of devices from the group of devices 130, and the removal of the group of devices 130.

In some embodiments, the first node 111 may be the AMF node and the second node 112 may be the NRF. In some of such embodiments, the first indication may be the Nnrf Register message, and the change may be one of: the addition or removal of devices from the group of devices 130, the removal of the group of devices 130, and the change to group data of the virtual network.

### Action 802

In this Action 802, the second node 112 may receive a fourth indication from the third node 113. The fourth indication may request discovery of the first node 111, for example, discovery of a UDM having the capability or discovery of an AMF having the capability.

In some embodiments, the first node 111 may be a UDM, the second node 112 may be an NRF, and the third node 113 may be the UDR.

In some of these embodiments wherein the first node 111 may be the UDM, the second node 112 may be the NRF, and the third node 113 may be the UDR, the first indication may be the Nnrf Register message, the fourth indication may be an Nnrf_Discovery request message, and the change may be one of: the addition or removal of devices from the group of devices 130, and the removal of the group of devices 130.

In other embodiments, the first node 111 may be the AMF, the second node 112 may be the NRF, and the third node 113 may be the UDM.

In some of these other embodiments wherein the first node 111 may be the AMF, the second node 112 may be the NRF, and the third node 113 may be the UDM, the first indication may be the Nnrf Register message, the fourth indication may be an Nnrf_Discovery request message, and the change may be one of: the addition or removal of devices from the group of devices 130, the removal of the group of devices 130, and the change to group data of the virtual network.

### Action 803

In this Action 803, the second node 112 sends, based on the received first indication, another indication to the third node 113 operating in the communications system 100. The another indication indicates the capability of the first node 111. The another indication may be a fifth indication sent in response to the received fourth indication.

In some embodiments, one of the following options may apply. In some embodiments, the first indication may further indicate the address to which the notification may be sent, and the fifth indication may indicate the indicated address. In other embodiments, the fourth indication may request provision of the address to which the notification may be sent, and the fifth indication may indicate the indicated address.

In some embodiments, the first node 111 may be a UDM, the second node 112 may be an NRF, and the third node 113 may be the UDR.

In some of these embodiments wherein the first node 111 may be the UDM, the second node 112 may be the NRF, and the third node 113 may be the UDR, the first indication may be the Nnrf Register message, the another indication may be an Nnrf_Discovery answer message, and the change may be one of: the addition or removal of devices from the group of devices 130, and the removal of the group of devices 130.

In other embodiments, the first node 111 may be the AMF, the second node 112 may be the NRF, and the third node 113 may be the UDM.

In some of these other embodiments wherein the first node 111 may be the AMF, the second node 112 may be the NRF, and the third node 113 may be the UDM, the first indication may be the Nnrf Register message, the another indication may be an Nnrf_Discovery answer message, and the change may be one of: the addition or removal of devices from the group of devices 130, the removal of the group of devices 130, and the change to group data of the virtual network.

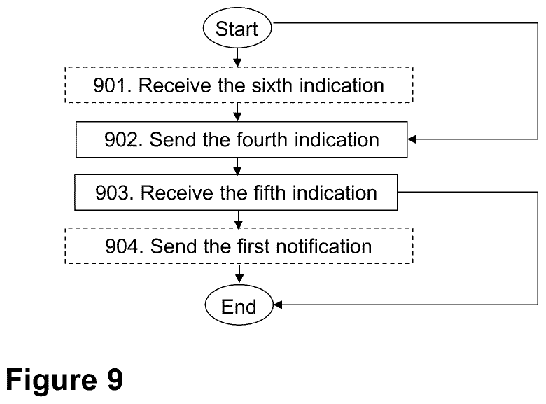

Embodiments of a computer-implemented method performed by the third node 113, will now be described with reference to the flowchart depicted in FIG. 9. The method may be understood to be for handling information. The third node 113 operates in the communications system 100.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, in some embodiments, the first node 111 may be a UDM, the second node 112 may be an NRF, and the third node 113 may be a UDR. In other embodiments, the first node 111 may be an AMF, the second node 112 may be an NRF, and the third node 113 may be a UDM.

### Action 901

In this Action 901, the third node 113 may receive a sixth indication from the fifth node 115 operating in the communications network 100. The sixth indication may indicate occurrence of the first change. The first change may affect two or more of the devices in the group of devices 130.

As described earlier, the change may be one of: a) the addition or removal of two or more devices from the group of devices 130, b) the removal of the group of devices 130, and c) the change to the group data of the virtual network, e.g., a 5G VN. The change may affect two or more of the devices in the group of devices 130.

The sixth indication may be, for example, a Nudr_Notification of a group data change, or a Nudm_Parameter_Provisioning message. This may be understood to be a new notification for the group of devices 130, wherein the provisioning system may refrain from sending individual notifications, one of each of the two or more devices of the group of devices 130 which may have undergone the first change.

In some examples, the Nudm_Parameter_Provisioning message may comprise an identifier of the group of devices 130, e.g., External Group Id. In a particular example, the Nudm_Parameter_Provisioning (External Group Id, UE1, UE2, . . . . UEn, 5GVNGroupData).

The receiving, in this Action 901 may be performed, e.g., via the fourth link 154.

### Action 902

The third node 113, in this Action 902, sends the fourth indication to the second node 112 operating in the communications system 100. As described earlier, the fourth indication requests discovery of the first node 111 having the capability to receive the notification indicating the change to information pertaining to the integrity of the group of devices 130 operating in the communications system 100. The change may affect two or more of the devices in the group of devices 130. That is, the change may be a group data change.

In some embodiments, the fourth indication may request provision of the address to which the notification may be sent.

The fourth indication may be, for example, an Nnrf_Discovery message.

### Action 903

The third node 113 then, in this Action 903, receives, based on the sent fourth indication, the fifth indication from the second node 112. The fifth indication indicates the capability of the first node 111.

In some embodiments wherein the fourth indication may request provision of the address to which the notification may be sent, the fifth indication may indicate the indicated address.

The fifth indication may be, for example, an Nnrf_Discovery answer.

When the third node 113 may, in this Action 903, discover in the second node 112, a consumer of the third node 113 such as the first node 111, if the address, which may be referred to as a group data change notification address, is provided as part of the NF Profile, the third node 113 may understand that the consumer of the third node 113 may require receiving the first notification, e.g., the group based related notification, instead of receiving individual notifications for each device inside the group of devices 130. In some embodiments, this may mean that when the UDR may discover a UDR consumer, e.g., the UDM, in the NRF, if the group data change notification address is provided as part of the NF Profile, it may then understand that the UDR consumer may require receiving group based related notifications instead of receiving individual notifications for each UE inside the group In other examples, this may mean that when the UDM may discover an UDM consumer, e.g., the AMF, in the NRF, if the group membership notification address is provided as part of the NF Profile, the UDM may then understand that the UDM consumer may require receiving group based related notifications instead of receiving individual notifications for each UE inside the group of devices 130.

### Action 904

In this Action 904, the third node 113 sends, based on the received sixth indication in Action 901, the first notification to the first node 111 operating in the communications system 100. The first notification indicates the first change to the information pertaining to the group of devices 130.

In some embodiments wherein the fourth indication may request provision of the address to which the notification may be to be sent, the first notification may be sent to the indicated address.

In some examples, this may mean that, if the UDR NF consumer, e.g., the UDM, registered the group data change default notification address, upon group data modification, the UDR may be able to notify the UDR consumer, e.g., the UDM, about this change in just one query using a new notification, e.g., a GROUP UPDATE or GROUP_REMOVAL, using the default notification address registered by the UDR NF Consumer, e.g., UDM. This notification may include the information updated related to this group. Group data changes may include the following situations: a) removal or addition of several UEs within a group of UEs, b) removal of the complete group, and c) 5G VN data.

In other examples, this may mean that, if the UDM NF consumer, e.g., the AMF, registered the SDM group data change default notification address, upon group data change notification reception from the UDR, the UDM may be able to notify the UDM NF Consumer about the group data change in just one query using a new SDM notification, e.g., a GROUP UPDATE or GROUP_REMOVAL, using the default notification address registered by the UDM NF consumer. This notification may include the information updated related to this group, such as removal or addition of several UEs within a group of UEs, and 5G VN data.

In some embodiments, the sixth indication and the first notification may comprise a seventh indication of a second number of devices from the group of devices 130 to which the first change may affect.

In some embodiments, the first node 111 may be the UDM, the second node 112 may be the NRF, and the third node 113 may be the UDR.

In some of these embodiments wherein the first node 111 may be the UDM, the second node 112 may be the NRF, and the third node 113 may be the UDR, the fourth indication may be the Nnrf Register message, the first notification may be the Nudr_Notification message, and the change may be one of: the addition or removal of devices from the group of devices 130, and the removal of the group of devices 130.

In other embodiments, the first node 111 may be the AMF, the second node 112 may be the NRF, and the third node 113 may be the UDM.

In some of these other embodiments wherein the first node 111 may be the AMF, the second node 112 may be the NRF, and the third node 113 may be the UDM, the fourth indication may be the Nnrf Register message, the first notification may be the Nudm_SDM_Notification message, and the change may be one of: the addition or removal of devices from the group of devices 130, the removal of the group of devices 130, and the change to group data of the virtual network.

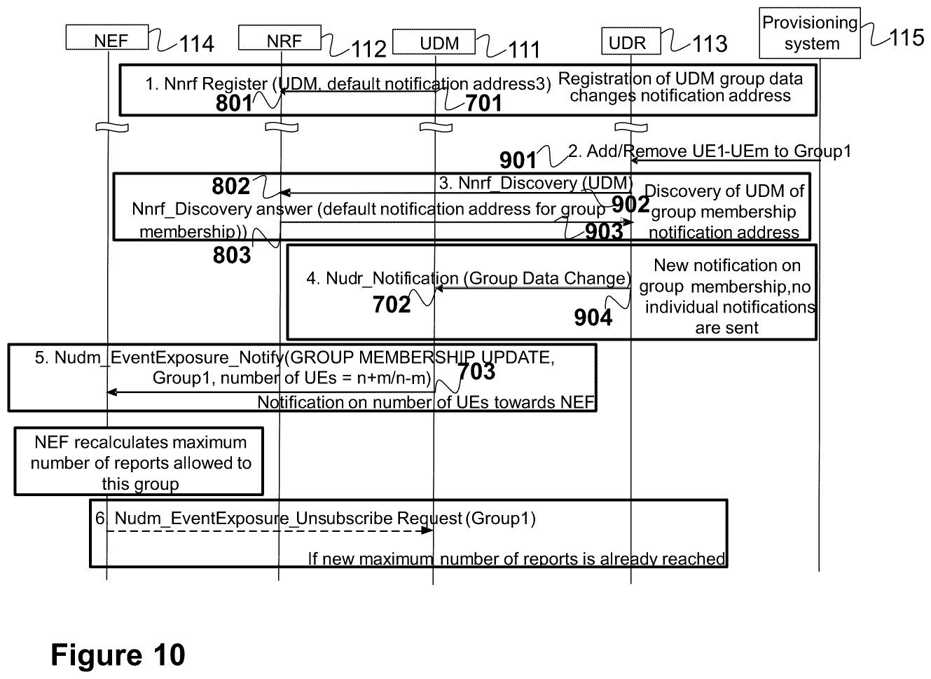

Several non-limiting examples of a method in the communications system 100 according to embodiments herein will now be described in the next FIGS. 10-13.

FIG. 10 is a signalling diagram depicting a non-limiting example of a method performed in the communications system 100, according to embodiments herein. The example of FIG. 10 depicts a notification on group data changes, the changes being UEs being added or removed to the group of devices 130 via an Event Exposure notification. In FIG. 10, the first node 111 is a UDM, the second node 112 is an NRF, the third node 113 is a UDR, the fourth node 114 is a NEF, and the fifth node 115 is a Provisioning system. In Step 1, the first node 111, in accordance with Action 701 and Action 801, sends the first indication to the second node 112 as an Nnrf Register message. The first indication comprises the address as a default notification address3. By sending the first indication, the first node 111 registers the address as a UDM group data change default notification address in the NRF. In Step 2, the third node 113, in accordance with Action 901, receives the sixth indication from the fifth node 115 indicating the occurrence of the first change, in this case the addition or removal of UEs within the group of devices 130, particularly, to add or remove UE-1-UEm from Group 1. In Step 3, in accordance with Action 902 and Action 802, the third node 113 sends the fourth indication to the second node 112 as an Nnrf_Discovery message for a UDM. By sending the fourth indication, the third node 113, the UDR, may be enabled to perform the discovery of the UDM group data change default notification address via the NRF. Next, in accordance with Action 803 and 903, the second node 112 sends the fifth indication to the third node 113 as an Nnrf_Discovery answer indicating the default notification address for group membership of the first node 111. In Step 4, the third node 113, in accordance with Action 904 and Action 702, sends the first notification, that is, the new notification described in embodiments herein, to the first node 111 as a Nudr_Notification of a Group Data Change about group data changes performed by the UDR. The first notification may be understood as a new notification on group membership. By sending the first notification, the third node 113 may refrain from sending individual notifications on group data changes. In Step 5, the first node 111, in accordance with Action 703 sends the second notification to the fourth node 114 with an Event Exposure notification, particularly as a Nudm_EventExposure_Notify indicating a Group membership update to Group 1 to update the number of UEs in the group of devices 130 in the NEF. The second notification further indicates that the second indication of the first number of devices remaining in the group of devices 130 after the addition of n+m devices or the removal of n−m devices. The receipt of the second notification comprising the second indication enables the fourth node 114 to the recalculate the maximum number of reports allowed for this group of devices 130, that is, Group 1. In Step 6, if the new maximum number of reports is already reached after the recalculation, the fourth node 114 sends a further indication to the first node 111 as a Nudm_EventExposure_Unsubscribe Request, requesting to stop the notification of the event that was originally requested in the event subscription request, to terminate an event subscription for the group of devices 130 created previously by the NEF in the UDM.

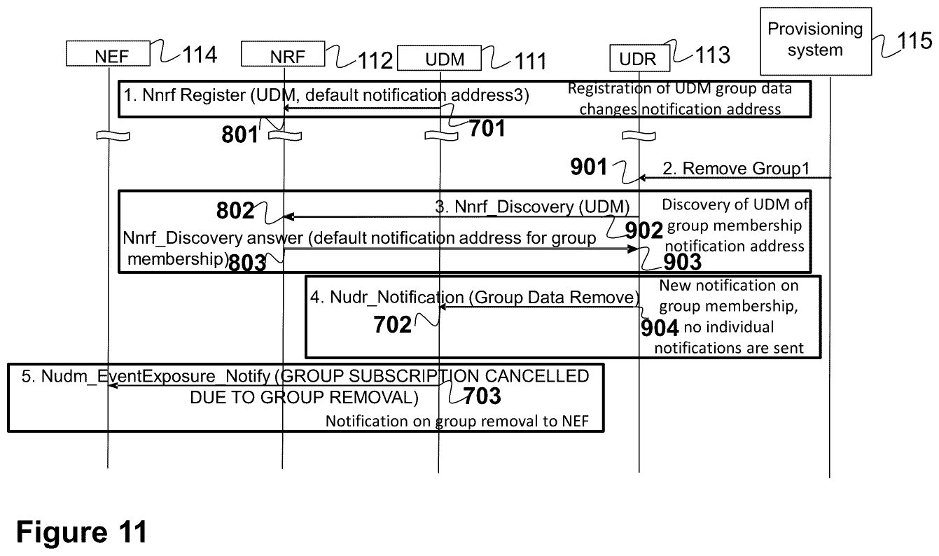

FIG. 11 is a signalling diagram depicting another non-limiting example of a method performed in the communications system 100, according to embodiments herein. The example of FIG. 11 depicts a notification on a group data change, the change being that the group of devices 130 is removed. In FIG. 11, the first node 111 is a UDM, the second node 112 is an NRF, the third node 113 is a UDR, the fourth node 114 is a NEF, and the fifth node 115 is a Provisioning system. The description of Step 1, Step 3 and Step 4 is the same as that for FIG. 10. The difference is that in this Figure, the third node 113 in Step 2, in accordance with Action 901, receives the sixth indication from the fifth node 115 indicating the occurrence of the first change, in this case to the entire removal of the group of devices 130, Group 1. In Step 4, the new notification is about the group data removal performed by the UDR. Then in Step 5, the first node 111, in accordance with Action 703 sends the second notification to the fourth node 114 as an Event Exposure notification, particularly, as a Nudm_EventExposure_Notify message indicating t to cancel an Event Exposure group subscription due to the group removal.

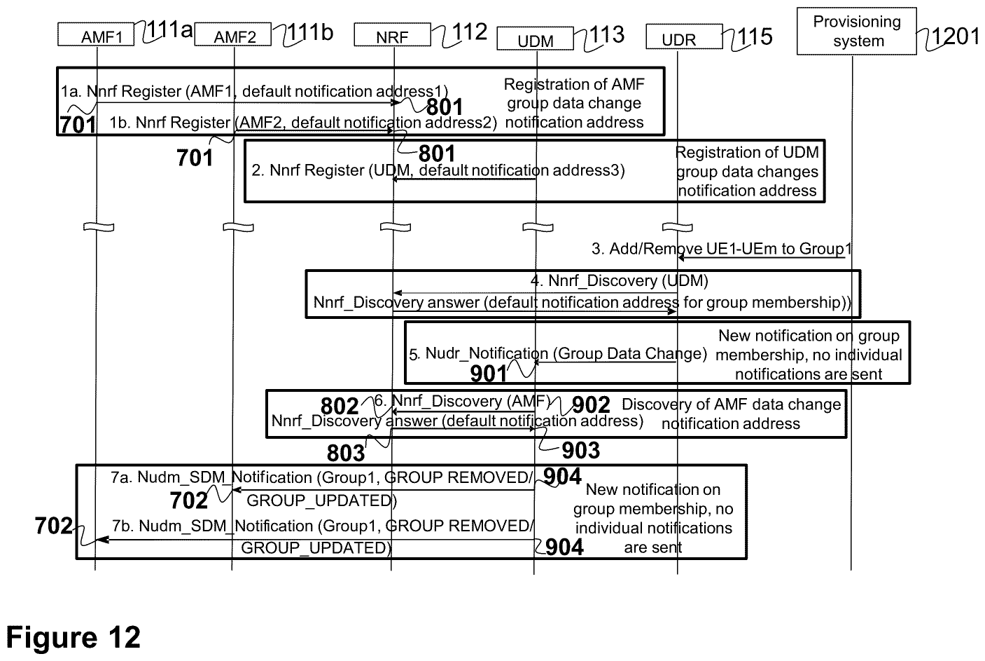

FIG. 12 is a signalling diagram depicting yet another non-limiting example of a method performed in the communications system 100, according to embodiments herein. The example of FIG. 12 depicts a notification on group data changes, the changes being UEs added or removed to the group of devices 130 via an SDM notification. In FIG. 12, there are two different first nodes 111a, 111b, each of them being an AMF, AMF1 and AMF2, the second node 112 is an NRF, the third node 113 is a UDM, and the fifth node 115 is a UDR. Also depicted in this Figure is a Provisioning system 1201. In Step 1a and Step 1b, respectively, each of the first nodes 111, in accordance with Action 701 and Action 801, sends a respective first indication to the second node 112 as an Nnrf Register message. In Step 1a, AMF1 sends the first indication comprising the address as its default notification address1. In Step 1b, AMF2 sends the first indication comprising the address as its default notification address2. By sending the respective first indications, the first nodes 111a, 111b register their respective address as an AMF group data change default notification address in the NRF. In Step 2, the third node 113 also registers with the second node 112 by sending an Nnrf Register to register its address as a UDM group data change default notification address in the NRF. In Step 3, the fifth node 115 receives an indication from the provisioning system 1201 indicating the occurrence of the first change, in this case the addition or removal of UEs, particularly UE-1-UEm to/from the group of devices 130 Group 1, or even the complete group removal. In Step 4, the fifth node 115 sends a discovery request to the second node 112 as an Nnrf_Discovery message for the discovery of the UDM group data change default notification address via the NRF. By sending the discovery request, the fifth node 115 may be enabled to discover the group membership notification address of the third node 113. The second node 112 sends a reply to the fifth node 115 as an Nnrf_Discovery answer indicating the default notification address for group membership of the third node 113. In Step 5, the third node 113, in accordance with Action 901, receives the sixth indication from the fifth node 115 indicating the occurrence of the first change, in this case the addition or removal of UE-1-UEm from the group of devices 130 Group 1 performed by the UDR. In Step 6, in accordance with Action 902 and Action 802, the third node 113 sends the fourth indication to the second node 112 as an Nnrf_Discovery message for the discovery of the AMF group data change default notification address. By sending the fourth indication, the third node 113 may be enabled to discover the group membership notification address of, in this case, the first nodes 111a, 111b. Next, in accordance with Action 803 and 903, the second node 112 sends the fifth indication to the third node 113 as an Nnrf_Discovery answer indicating the default notification address for group membership of the first nodes 111a, 111b. In Steps 7a and 7b, the third node 113, in accordance with Action 904 and Action 702, sends a respective first notification to the first nodes 111a and 111b, respectively, as a Nudm_SDM_Notification of the removal of the group of devices 130, as indicated by “GROUP REMOVED” in FIG. 12, or of the update of the group of devices 130, as indicated by “GROUP_UPDATED” in the Figure. Each of the respective first notifications may be understood as a new notification on group membership. In Step 7a, the third node 113 sends the first notification to one of the first nodes 111b, AMF2, as a new SDM notification about the group data change performed by the UDM, particularly, a “Nudm_SDM_Notification (Group1, GROUP REMOVED/GROUP_UPDATED)”, and in Step 7b, the third node 113 sends the first notification to the other first node 111a, AMF1 as a “Nudm_SDM_Notification (Group1, GROUP REMOVED/GROUP_UPDATED)”. By sending the respective first notifications, the third node 113 may refrain from sending individual notifications on group data changes. It may be noted that in FIG. 12, Step 2 corresponds to Step 1 of FIG. 10, Step 3 of FIG. 12 corresponds to Step 2 of FIG. 10, Step 4 of FIG. 12 of corresponds to Step 3 of FIG. 10, Step 5 of FIG. 12 corresponds to Step 4 of FIG. 10, and Step 7 of FIG. 12 corresponds to Step 5 of FIG. 10. It may therefore be understood that while FIG. 12 has been described with the AMFs being the first nodes 111a, 111b and the UDM being the third node 113, in Steps 2-7, FIG. 12 can also be read as in FIG. 10, namely, with the UDM being the first node 111, the NRF being the second node 112, the third node 113 being the UDR, and the provisioning system being the fifth node 115.

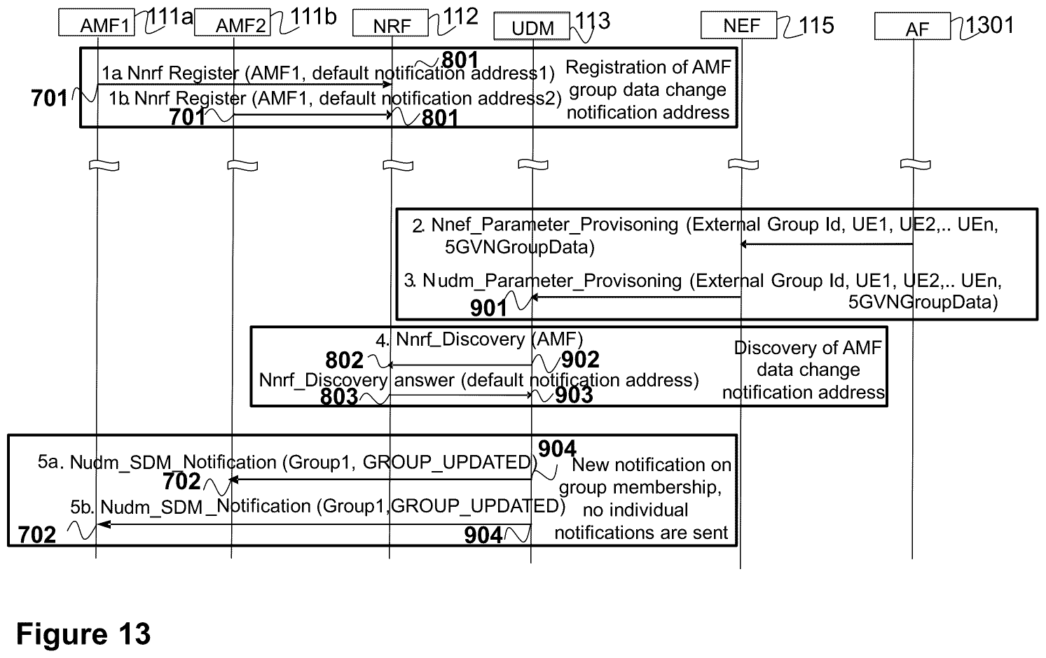

FIG. 13 is a signalling diagram depicting a further non-limiting example of a method performed in the communications system 100, according to embodiments herein. The example of FIG. 13 depicts a notification on a group data change, the change being to 5G VN group membership. As in FIG. 12, in FIG. 13, there are two different first nodes 111a, 111b, each of them being an AMF, AMF1 and AMF2, the second node 112 is an NRF, the. third node 113 is a UDM, and the fifth node 115 is a NEF. Also depicted in this Figure is an Application Function (AF) 1301. Step 1a and Step 1b are the same as in FIG. 12 and show the registration of the AMF group data change default notification address in the NRF. In Step 2, the fifth node 115 receives an indication from the AF 1301 indicating the occurrence of the first change, in this case the provisioning of 5G VN Group data from the AF 1301. This indication is received as a Nnef_Parameter_Provisioning (ExternalGroup Id, UE1, UE2, . . . . UEn, 5GVNGroupData) message. In Step 3 the third node 113, in accordance with Action 901, receives the sixth indication from the fifth node 115 indicating the occurrence of the first change as an Nudm_Parameter_Provisioning (External Group Id, UE1, UE2, . . . . UEn, 5GVNGroupData) message. Step 4 has a same description as Step 6 in FIG. 12 illustrating the discovery of the AMF group data change default notification address from the UDM. In Steps 5a and 5b, the third node 113, in accordance with Action 904 and Action 702, sends a respective first notification, as new SDM notification about the group data change performed by the UDM to the first nodes 111b and 111a, respectively. Particularly, the respective first notification is sent as a Nudm_SDM_Notification indicating that the group of devices 130, Group1, has been updated, as indicated by “GROUP_UPDATED” in FIG. 13. Each of the respective first notifications may be understood as a new notification on group membership. In Step 5a, the third node 113 sends the first notification to one of the first nodes 111b, AMF2, as a “Nudm_SDM_Notification (Group1, GROUP_UPDATED)”, and in Step 7b, the third node 113 sends the first notification to the other first node 111a, AMF1, as a “Nudm_SDM_Notification (Group1, GROUP_UPDATED)”.

Certain embodiments disclosed herein may provide one or more of the following technical advantage(s), which may be summarized as follows.

As a first advantage, embodiments herein may be understood to enable the first node 111, e.g., a UDM, to be notified about changes to the integrity of the group of devices 130, that is, Group Data notification changes and, in turn, notify about these changes to other consumers of the first node 111, e.g., UDM NF consumers.

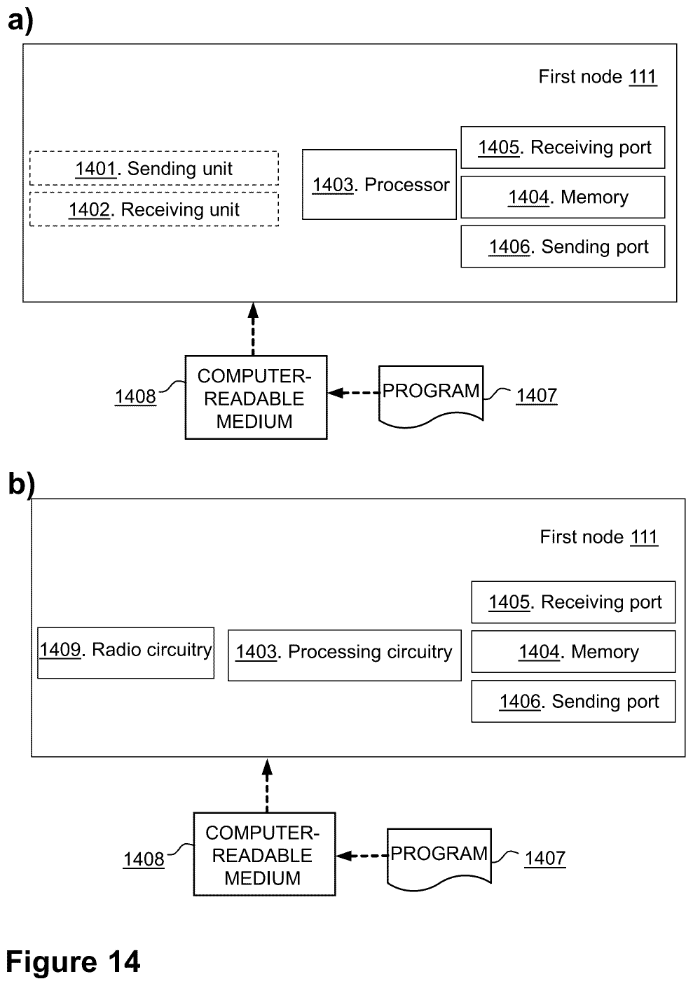

FIG. 14 depicts two different examples in panels a) and b), respectively, of the arrangement that the first node 111 may comprise to perform the method actions described above in relation to FIG. 7 and/or FIGS. 10-13. In some embodiments, the first node 111 may comprise the following arrangement depicted in FIG. 14a. The first node 111 may be understood to be for handling information. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the first node 111 and will thus not be repeated here. For example, in some embodiments, the first node 111 may be configured to be a UDM, the second node 112 may be configured to be an NRF, and the third node 113 may be configured to be a UDR. In other embodiments, the first node 111 may be configured to be an AMF, the second node 112 may be configured to be an NRF, and the third node 113 may be configured to be a UDM.

The first node 111 is configured to, e.g., by means of a sending unit 1401 within the first node 111 configured to, send the first indication to the second node 112 configured to operate in the communications system 100. The first indication is configured to indicate the capability of the first node 111 to receive the notification configured to indicate the change to the information configured to pertain to the integrity of the group of devices 130 configured to operate in the communications system 100.

The first node 111 is also configured to, e.g., by means of a receiving unit 1402 within the first node 111 configured to, receive, based on the first indication configured to be sent, the first notification from the third node 113 configured to operate in the communications system 100. The first notification is configured to indicate the first change to the information configured to pertain to the group of devices 130. The first change is configured to affect two or more of the devices in the group of devices 130.

In some embodiments, the first indication may be further configured to indicate the address to which the notification may have to be sent, and the receiving may be configured to be at the indicated address.

In some embodiments, the change may be configured to be one of: a) the addition or removal of the two or more devices from the group of devices 130, b) the removal of the group of devices 130, and c) the change to group data of the virtual network.

In some embodiments, wherein the change may be configured to be the addition or removal of the two or more devices from the group of devices 130, and the first node 111 may be further configured to, e.g., by means of the sending unit 1401 within the first node 111 configured to, send, based on the first notification configured to be received, the second notification to the fourth node 114 configured to operate in the communications network 100. The second notification may be configured to indicate the first change.

In some embodiments, the second notification may be configured to comprise the second indication of the first number of devices configured to remain in the group of devices 130 after the addition or removal of the two or more devices from the group of devices 130.

In some embodiments, one of the following may apply. According to a first option, the first node 111 may be configured to be the UDM, the second node 112 may be configured to be the NRF, and the third node 113 may be configured to be the UDR. According to a second option, the first node 111 may be configured to be an AMF, the second node 112 may be configured to be an NRF, and the third node 113 may be configured to be a UDM.

In some embodiments, one of the following may apply. According to a first option, the first node 111 may be configured to be the UDM, the second node 112 may be configured to be the NRF, the third node 113 may be configured to be the UDR, the first indication may be configured to be the Nnrf Register message, the first notification may be configured to be the Nudr_Notification message, and the change may be configured to be one of: the addition or removal of devices from the group of devices 130, and the removal of the group of devices 130. According to a second option, the first node 111 may be configured to be the AMF, the second node 112 may be configured to be the NRF, the third node 113 may be configured to be the UDM, the first indication may be configured to be an Nnrf Register message, the first notification may be configured to be a Nudm_SDM_Notification message, and the change may be configured to be one of: the addition or removal of devices from the group of devices 130, the removal of the group of devices 130, and the change to group data of the virtual network.

The embodiments herein may be implemented through one or more processors, such as a processor 1403 in the first node 111 depicted in FIG. 14, together with computer program code for performing the functions and actions of the embodiments herein. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1404 comprising one or more memory units. The memory 1404 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, the group of devices 130 and/or another node through a receiving port 1405. In some examples, the receiving port 1405 may be, for example, connected to one or more antennas in the first node 111. In other embodiments, the first node 111 may receive information from another structure in the communications system 100 through the receiving port 1405. Since the receiving port 1405 may be in communication with the processor 1403, the receiving port 1405 may then send the received information to the processor 1403. The receiving port 1405 may also be configured to receive other information.

The processor 1403 in the first node 111 may be further configured to transmit or send information to e.g., the second node 112, the third node 113, the fourth node 114, the fifth node 115, the group of devices 130, another node and/or another structure in the communications system 100, through a sending port 1406, which may be in communication with the processor 1403, and the memory 1404.

Those skilled in the art will also appreciate that any of the units 1401-1402 described above may refer to a combination of analog and digital circuits, and/or one or more processors configured with software and/or firmware, e.g., stored in memory, that, when executed by the one or more processors such as the processor 1403, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1401-1402 described above may be the processor 1403 of the first node 111, or an application running on such processor.

Thus, the methods according to the embodiments described herein for the first node 111 may be respectively implemented by means of a computer program 1407 product, comprising instructions, i.e., software code portions, which, when executed on at least one processor 1403, cause the at least one processor 1403 to carry out the actions described herein, as performed by the first node 111. The computer program 1407 product may be stored on a computer-readable storage medium 1408. The computer-readable storage medium 1408, having stored thereon the computer program 1407, may comprise instructions which, when executed on at least one processor 1403, cause the at least one processor 1403 to carry out the actions described herein, as performed by the first node 111. In some embodiments, the computer-readable storage medium 1408 may be a non-transitory computer-readable storage medium, such as a CD ROM disc, a memory stick, or stored in the cloud space. In other embodiments, the computer program 1407 product may be stored on a carrier containing the computer program, wherein the carrier is one of an electronic signal, optical signal, radio signal, or the computer-readable storage medium 1408, as described above.

The first node 111 may comprise an interface unit to facilitate communications between the first node 111 and other nodes or devices, e.g., the second node 112, the third node 113, the fourth node 114, the fifth node 115, the group of devices 130, another node and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 14b. The first node 111 may comprise a processing circuitry 1403, e.g., one or more processors such as the processor 1403, in the first node 111 and the memory 1404. The first node 111 may also comprise a radio circuitry 1409, which may comprise e.g., the receiving port 1405 and the sending port 1406. The processing circuitry 1403 may be configured to, or operable to, perform the method actions according to FIG. 7 and/or FIGS. 10-13, in a similar manner as that described in relation to FIG. 14a. The radio circuitry 1409 may be configured to set up and maintain at least a wireless connection with the second node 112, the third node 113, the fourth node 114, the fifth node 115, the group of devices 130, another node and/or another structure in the communications system 100.

Hence, embodiments herein also relate to the first node 111 operative for handling indications, the first node 111 being operative to operate in the communications system 100. The first node 111 may comprise the processing circuitry 1403 and the memory 1404, said memory 1404 containing instructions executable by said processing circuitry 1403, whereby the first node 111 is further operative to perform the actions described herein in relation to the first node 111, e.g., in FIG. 7 and/or FIGS. 10-13.

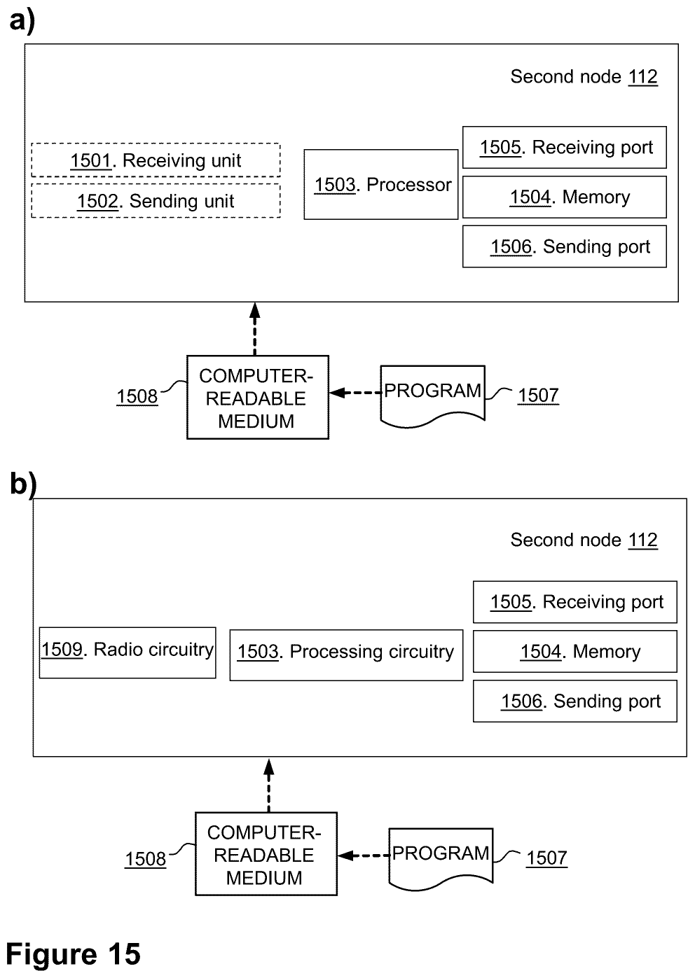

FIG. 15 depicts two different examples in panels a) and b), respectively, of the arrangement that the second node 112, may comprise to perform the method actions described above in relation to FIG. 8 and/or FIGS. 10-13. In some embodiments, the second node 112 may comprise the following arrangement depicted in FIG. 15a. The second node 112 may be understood to be for handling information. The second node 112 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 15, optional boxes are indicated by dashed lines. The detailed description of some of the following corresponds to the same references provided above, in relation to the actions described for the second node 112 and will thus not be repeated here. For example, in some embodiments, the first node 111 may be configured to be a UDM, the second node 112 may be configured to be an NRF, and the third node 113 may be configured to be a UDR. In other embodiments, the first node 111 may be configured to be an AMF, the second node 112 may be configured to be an NRF, and the third node 113 may be configured to be a UDM.

The second node 112 is configured to, e.g., by means of a receiving unit 1501 within the second node 112 configured to, receive the first indication from the first node 111 configured to operate in the communications system 100. The first indication is configured to indicate the capability of the first node 111 to receive the notification configured to indicate the change to information configured to pertain to the integrity of the group of devices 130 configured to operate in the communications system 100.

The second node 112 is also configured to, e.g., by means of a sending unit 1502 within the second node 112 configured to, send, based on the first indication configured to be received, the another indication to the third node 113 configured to operate in the communications system 100. The another indication is configured to indicate the capability of the first node 111.

In some embodiments, the second node 112 may be configured to, e.g., by means of the receiving unit 1501 within the second node 112 configured to, receive the fourth indication from the third node 113. The fourth indication may be configured to request the discovery of the first node 111. The another indication may be configured to be the fifth indication configured to be sent in response to the fourth indication configured to be received.

In some embodiments one of the following options may apply. According to a first option, the first indication may be configured to further indicate the address to which the notification may have to be sent, and the fifth indication may be configured to indicate the address configured to be indicated. According to a second option, the fourth indication may be configured to request provision of the address to which the notification may have to be sent and the fifth indication may be configured to indicate the address configured to be indicated.

In some embodiments, the change may be configured to be one of: a) the addition or removal of the two or more devices from the group of devices 130, b) the removal of the group of devices 130, and c) the change to group data of the virtual network.

In some embodiments, one of the following may apply. According to a first option, the first node 111 may be configured to be the UDM, the second node 112 may be configured to be the NRF, and the third node 113 may be configured to be the UDR. According to a second option, the first node 111 may be configured to be an AMF, the second node 112 may be configured to be an NRF, and the third node 113 may be configured to be a UDM.

In some embodiments, one of the following may apply. According to a first option, the first node 111 may be configured to be the UDM, the second node 112 may be configured to be the NRF, the third node 113 may be configured to be the UDR, the first indication may be configured to be the Nnrf Register message, the another indication may be configured to be the Nnrf_Discovery answer message, and the change may be configured to be one of: the addition or removal of devices from the group of devices 130, and the removal of the group of devices 130. According to a second option, the first node 111 may be configured to be the AMF, the second node 112 may be configured to be the NRF, the third node 113 may be configured to be the UDM, the another indication may be configured to be the Nnrf_Discovery answer message, and the change may be configured to be one of: the addition or removal of devices from the group of devices 130, the removal of the group of devices 130, and the change to group data of the virtual network.

The embodiments herein may be implemented through one or more processors, such as a processor 1503 in the second node 112 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1504 comprising one or more memory units. The memory 1504 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, the fifth node 115, the group of devices 130, and/or another node, through a receiving port 1505. In some examples, the receiving port 1505 may be, for example, connected to one or more antennas in the second node 112. In other embodiments, the second node 112 may receive information from another structure in the communications system 100 through the receiving port 1505. Since the receiving port 1505 may be in communication with the processor 1503, the receiving port 1505 may then send the received information to the processor 1503. The receiving port 1505 may also be configured to receive other information.

The processor 1503 in the second node 112 may be further configured to transmit or send information to e.g., the first node 111, the third node 113, the fourth node 114, the fifth node 115, the group of devices 130, another node and/or another structure in the communications system 100, through a sending port 1506, which may be in communication with the processor 1503, and the memory 1504.

Those skilled in the art will also appreciate that any of the units 1501-1502 described above may refer to a combination of analog and digital circuits, and/or one or more processors configured with software and/or firmware, e.g., stored in memory, that, when executed by the one or more processors such as the processor 1503, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1501-1502 described above may be the processor 1503 of the second node 112, or an application running on such processor.

Thus, the methods according to the embodiments described herein for the second node 112 may be respectively implemented by means of a computer program 1507 product, comprising instructions, i.e., software code portions, which, when executed on at least one processor 1503, cause the at least one processor 1503 to carry out the actions described herein, as performed by the second node 112. The computer program 1507 product may be stored on a computer-readable storage medium 1508. The computer-readable storage medium 1508, having stored thereon the computer program 1507, may comprise instructions which, when executed on at least one processor 1503, cause the at least one processor 1503 to carry out the actions described herein, as performed by the second node 112. In some embodiments, the computer-readable storage medium 1508 may be a non-transitory computer-readable storage medium, such as a CD ROM disc, a memory stick, or stored in the cloud space. In other embodiments, the computer program 1507 product may be stored on a carrier containing the computer program, wherein the carrier is one of an electronic signal, optical signal, radio signal, or the computer-readable storage medium 1508, as described above.

The second node 112 may comprise an interface unit to facilitate communications between the second node 112 and other nodes or devices, e.g., the first node 111, the third node 113, the fourth node 114, the fifth node 115, the group of devices 130, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 15b. The second node 112 may comprise a processing circuitry 1503, e.g., one or more processors such as the processor 1503 in the second node 112 and the memory 1504. The second node 112 may also comprise a radio circuitry 1509, which may comprise e.g., the receiving port 1505 and the sending port 1506. The processing circuitry 1503 may be configured to, or operable to, perform the method actions according to FIG. 8 and/or FIGS. 10-13, in a similar manner as that described in relation to FIG. 15a. The radio circuitry 1509 may be configured to set up and maintain at least a wireless connection with the first node 111, the third node 113, the fourth node 114, the fifth node 115, the group of devices 130, another node and/or another structure in the communications system 100.

Hence, embodiments herein also relate to the second node 112 operative for handling information, the second node 112 being operative to operate in the communications system 100. The second node 112 may comprise the processing circuitry 1503 and the memory 1504, said memory 1504 containing instructions executable by said processing circuitry 1503, whereby the second node 112 is further operative to perform the actions described herein in relation to the second node 112, e.g., in FIG. 8 and/or FIGS. 10-13.

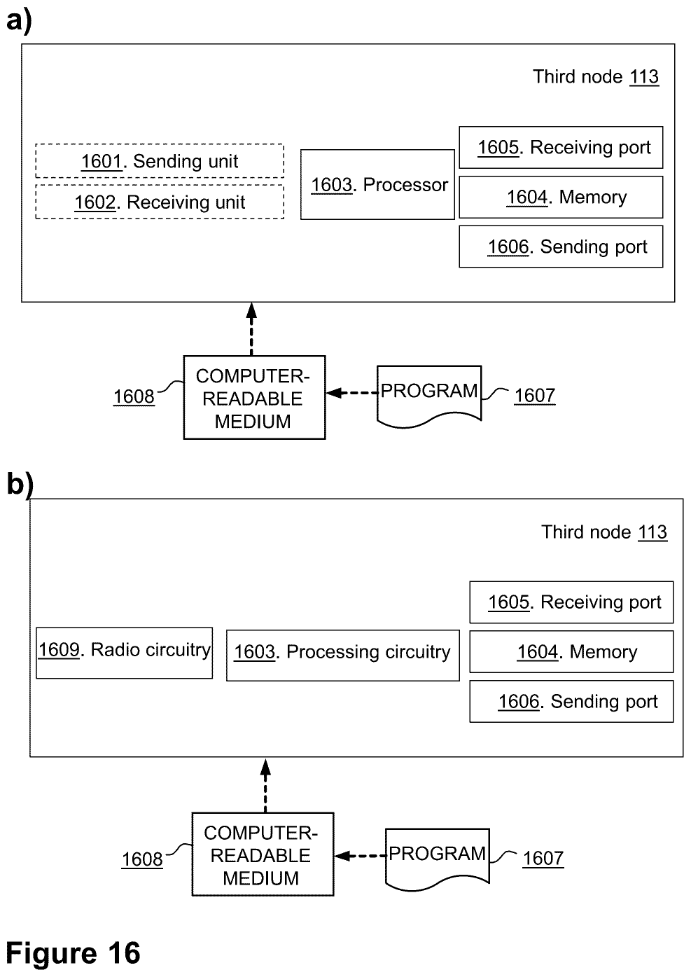

FIG. 16 depicts two different examples in panels a) and b), respectively, of the arrangement that the third node 113 may comprise to perform the method actions described above in relation to FIG. 9 and/or FIGS. 10-13. In some embodiments, the third node 113 may comprise the following arrangement depicted in FIG. 16a. The third node 113 may be understood to be for handling information. The third node 113 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 16, optional boxes are indicated by dashed lines. The detailed description of some of the following corresponds to the same references provided above, in relation to the actions described for the third node 113 and will thus not be repeated here. For example, in some embodiments, the first node 111 may be configured to be a UDM, the second node 112 may be configured to be an NRF, and the third node 113 may be configured to be a UDR. In other embodiments, the first node 111 may be configured to be an AMF, the second node 112 may be configured to be an NRF, and the third node 113 may be configured to be a UDM.

The third node 113 is configured to, e.g., by means of a sending unit 1601 within the third node 113 configured to, send the fourth indication to the second node 112 configured to operate in the communications system 100. The fourth indication is configured to request discovery of the first node 111 having the capability to receive the notification configured to indicate the change to the information configured to pertain to the integrity of the group of devices 130 configured to operate in the communications system 100.

The third node 113 is also configured to, e.g., by means of a receiving unit 1602 within the third node 113 configured to, receive, based on the fourth indication configured to be sent, the fifth indication from the second node 112. The fifth indication is configured to indicate the capability of the first node 111.

In some embodiments, the fourth indication may be configured to request provision of the address to which the notification may have to be sent, and the fifth indication may be configured to indicate the address configured to be indicated.

In some embodiments, the change may be configured to be one of: a) the addition or removal of the two or more devices from the group of devices 130, b) the removal of the group of devices 130, and c) the change to group data of the virtual network.

In some embodiments, the third node 113 may be also configured to, e.g., by means of the receiving unit 1602 within the third node 113 configured to, receive the sixth indication from the fifth node 115 configured to operate in the communications network 100. The sixth indication may be configured to indicate the occurrence of the first change. The first change may be configured to affect two or more of the devices in the group of devices 130.

In some embodiments, the third node 113 may be also configured to, e.g., by means of the sending unit 1601 within the third node 113 configured to, send, based on the sixth indication configured to be received, the first notification to the first node 111 configured to operate in the communications system 100. The first notification may be configured to indicate the first change to the information configured to pertain to the group of devices 130.

In some embodiments, the fourth indication may be configured to request provision of the address to which the notification may have to be sent and the first notification may be configured to be sent to the address configured to be indicated.

In some embodiments, the sixth indication and the first notification may be configured to comprise the seventh indication of the second number of devices from the group of devices 130 to which the first change may be configured to affect.

In some embodiments, one of the following may apply. According to a first option, the first node 111 may be configured to be the UDM, the second node 112 may be configured to be the NRF, and the third node 113 may be configured to be the UDR. According to a second option, the first node 111 may be configured to be an AMF, the second node 112 may be configured to be an NRF, and the third node 113 may be configured to be a UDM.

In some embodiments, one of the following may apply. According to a first option, the first node 111 may be configured to be the UDM, the second node 112 may be configured to be the NRF, the third node 113 may be configured to be the UDR, the fourth indication may be configured to be the Nnrf_Discovery message, the first notification may be configured to be the Nudr_Notification message, and the change may be configured to be one of: the addition or removal of devices from the group of devices 130, and the removal of the group of devices 130. According to a second option, the first node 111 may be configured to be the AMF, the second node 112 may be configured to be the NRF, the third node 113 may be configured to be the UDM, the fourth indication may be configured to be the Nnrf_Discovery message, the first notification may be configured to be a Nudm_SDM_Notification message, and the change may be configured to be one of: the addition or removal of devices from the group of devices 130, the removal of the group of devices 130, and the change to group data of the virtual network.

The embodiments herein may be implemented through one or more processors, such as a processor 1603 in the third node 113 depicted in FIG. 16, together with computer program code for performing the functions and actions of the embodiments herein. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1604 comprising one or more memory units. The memory 1604 is arranged to be used to store obtained information, store data, configurations, schedulings, and applications etc. to perform the methods herein when being executed in the third node 113.

In some embodiments, the third node 113 may receive information from, e.g., the first node 111, the second node 112, the fourth node 114, the fifth node 115, the group of devices 130, and/or another node, through a receiving port 1605. In some examples, the receiving port 1605 may be, for example, connected to one or more antennas in the third node 113. In other embodiments, the third node 113 may receive information from another structure in the communications system 100 through the receiving port 1605. Since the receiving port 1605 may be in communication with the processor 1603, the receiving port 1605 may then send the received information to the processor 1603. The receiving port 1605 may also be configured to receive other information.

The processor 1603 in the third node 113 may be further configured to transmit or send information to e.g., the first node 111, the second node 112, the fourth node 114, the fifth node 115, the group of devices 130, another node and/or another structure in the communications system 100, through a sending port 1606, which may be in communication with the processor 1603, and the memory 1604.

Those skilled in the art will also appreciate that the units 1601-1602 described above may refer to a combination of analog and digital circuits, and/or one or more processors configured with software and/or firmware, e.g., stored in memory, that, when executed by the one or more processors such as the processor 1603, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1601-1602 described above may be the processor 1603 of the third node 113, or an application running on such processor.

Thus, the methods according to the embodiments described herein for the third node 113 may be respectively implemented by means of a computer program 1607 product, comprising instructions, i.e., software code portions, which, when executed on at least one processor 1603, cause the at least one processor 1603 to carry out the actions described herein, as performed by the third node 113. The computer program 1607 product may be stored on a computer-readable storage medium 1608. The computer-readable storage medium 1608, having stored thereon the computer program 1607, may comprise instructions which, when executed on at least one processor 1603, cause the at least one processor 1603 to carry out the actions described herein, as performed by the third node 113. In some embodiments, the computer-readable storage medium 1608 may be a non-transitory computer-readable storage medium, such as a CD ROM disc, a memory stick, or stored in the cloud space. In other embodiments, the computer program 1607 product may be stored on a carrier containing the computer program, wherein the carrier is one of an electronic signal, optical signal, radio signal, or the computer-readable storage medium 1608, as described above.

The third node 113 may comprise an interface unit to facilitate communications between the third node 113 and other nodes or devices, e.g., the first node 111, the second node 112, the fourth node 114, the fifth node 115, the group of devices 130, another node and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 16b. The third node 113 may comprise a processing circuitry 1603, e.g., one or more processors such as the processor 1603, in the third node 113 and the memory 1604. The third node 113 may also comprise a radio circuitry 1609, which may comprise e.g., the receiving port 1605 and the sending port 1606. The processing circuitry 1603 may be configured to, or operable to, perform the method actions according to FIG. 9 and/or FIGS. 10-13, in a similar manner as that described in relation to FIG. 16a. The radio circuitry 1609 may be configured to set up and maintain at least a wireless connection with the first node 111, the second node 112, the fourth node 114, the fifth node 115, the group of devices 130, another node and/or another structure in the communications system 100.

Hence, embodiments herein also relate to the third node 113 operative for handling information, the third node 113 being operative to operate in the communications system 100. The third node 113 may comprise the processing circuitry 1603 and the memory 1604, said memory 1604 containing instructions executable by said processing circuitry 1603, whereby the third node 113 is further operative to perform the actions described herein in relation to the third node 113, e.g., in FIG. 9 and/or FIGS. 10-13.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 23.501 v17.2.0
2. 3GPP TS 23.502 v17.2.1
3. 3GPP TS 29.503 v17.4.0

1. A computer-implemented method, performed by a first node, for handling information, the first node operating in a communications system, the method comprising:
sending a first indication to a second node operating in the communications system, the first indication indicating a capability of the first node to receive a notification indicating a change to information pertaining to an integrity of a group of devices operating in the communications system, and
receiving, based on the sent first indication, a first notification from a third node operating in the communications system, the first notification indicating a first change to the information pertaining to the group of devices, the first change affecting two or more of the devices in the group of devices.

2. The computer-implemented method according to claim 1, wherein the first indication further indicates an address to which the notification is to be sent, and wherein the receiving is at the indicated address.

3. The computer-implemented method according to claim 1, wherein the change is one of:
a. an addition or removal of the two or more devices from the group of devices,
b. a removal of the group of devices, and
c. a change to group data of a virtual network.

4. The computer-implemented method according to claim 3, wherein the change is the addition or removal of the two or more devices from the group of devices, and wherein method further comprises:
sending, based on the received first notification, a second notification to a fourth node operating in the communications network, the second notification indicating the first change.

5. The computer-implemented method according to claim 4, wherein the second notification comprises a second indication of a first number of devices remaining in the group of devices after the addition or removal of the two or more devices from the group of devices.

6. The computer-implemented method according to claim 1, wherein one of:
a. the first node is a Unified Data Management, UDM, the second node is a Network Repository Function, NRF, and the third node is a Unified Data Repository, UDR, and
b. the first node is an Access and Mobility Management Function, AMF, the second node is an NRF, and the third node is a UDM.

7. The computer-implemented method according to claim 6, wherein at least one of:
a. the first node is the UDM, the second node is the NRF, the third node is the UDR, the first indication is an Nnrf Register message, the first notification is a Nudr_Notification message, and the change is one of: an addition or removal of devices from the group of devices, and the removal of the group of devices, and
b. the first node is the AMF, the second node is the NRF, the third node is the UDM, the first indication is an Nnrf Register message, the first notification is a Nudm_Subscriber Data Management, SDM, Notification message, and the change is one of: the addition or removal of devices from the group of devices, the removal of the group of devices, and the change to group data of the virtual network.

8. A computer-implemented method, performed by a second node, for handling information, the second node operating in a communications system, the method comprising:
receiving a first indication from a first node operating in the communications system, the first indication indicating a capability of the first node to receive a notification indicating a change to information pertaining to an integrity of a group of devices operating in the communications system, and
sending, based on the received first indication, another indication to a third node operating in the communications system, the another indication indicating the capability of the first node.

9. The computer-implemented method according to claim 8, further comprising:
receiving a fourth indication from the third node, the fourth indication requesting discovery of the first node, and wherein the another indication is a fifth indication sent in response to the received fourth indication.

10. The computer-implemented method according to claim 9, wherein one of:
a. the first indication further indicates an address to which the notification is to be sent, and wherein the fifth indication indicates the indicated address, and
b. the fourth indication requests provision of the address to which the notification is to be sent and wherein the fifth indication indicates the indicated address.

11. The computer-implemented method according to claim 8, wherein the change is one of:
a. an addition or removal of the two or more devices from the group of devices,
b. a removal of the group of devices, and
c. a change to group data of a virtual network.

12. The computer-implemented method according to claim 8, wherein one of:
a. the first node is a Unified Data Management, UDM, the second node is a Network Repository Function, NRF, and the third node is a Unified Data Repository, UDR, and b. the first node is an Access and Mobility Management Function, AMF, the second node is an NRF, and the third node is a UDM.

13. The computer-implemented method according to claim 12, wherein at least one of:
a. the first node is the UDM, the second node is the NRF, the third node is the UDR, the first indication is an Nnrf Register message, the another indication is an Nnrf_Discovery answer message, and the change is one of: an addition or removal of devices from the group of devices, and the removal of the group of devices, and
b. the first node is the AMF, the second node is the NRF, the third node is the UDM, the first indication is an Nnrf Register message, the another indication is an Nnrf_Discovery answer message, and the change is one of: the addition or removal of devices from the group of devices, the removal of the group of devices, and the change to group data of the virtual network.

14. A computer-implemented method, performed by a third node, for handling information, the third node operating in a communications system, the method comprising:
sending a fourth indication to a second node operating in the communications system, the fourth indication requesting discovery of a first node having a capability to receive a notification indicating a change to information pertaining to an integrity of a group of devices operating in the communications system, and
receiving, based on the sent fourth indication, a fifth indication from the second node, the fifth indication indicating the capability of the first node.

15. The computer-implemented method according to claim 14, wherein the fourth indication requests provision of an address to which the notification is to be sent, and wherein the fifth indication indicates the indicated address.

16. The computer-implemented method according to claim 14, wherein the change is one of:
a. an addition or removal of the two or more devices from the group of devices,
b. a removal of the group of devices, and
c. a change to group data of a virtual network.

17. The computer-implemented method according to claim 16, further comprising:
receiving a sixth indication from a fifth node operating in the communications network, the sixth indication indicating occurrence of the first change, the first change affecting two or more of the devices in the group of devices, and
sending, based on the received sixth indication, a first notification to the first node operating in the communications system, the first notification indicating the first change to the information pertaining to the group of devices.

18. The computer-implemented method according to claim 14, wherein the fourth indication requests provision of an address to which the notification is to be sent, and wherein the first notification is sent to the indicated address.

19. The computer-implemented method according to claim 17, wherein the sixth indication and the first notification comprise a seventh indication of a second number of devices from the group of devices to which the first change affects.

20. The computer-implemented method according to claim 14, wherein one of:
a. the first node is a Unified Data Management, UDM, the second node is a Network Repository Function, NRF, and the third node is a Unified Data Repository, UDR, and
b. the first node is an Access and Mobility Management Function, AMF, the second node is an NRF, and the third node is a UDM.

21-42. (canceled)
